(19) United States
(12) Patent Application Publication
(10) Pub. No.: US 2025/0083170 A1
(43) Pub. Date: Mar. 13, 2025

(54) FLUID SPRAY GUN TRIGGER MOUNTING AND RETENTION

(71) Applicant: Graco Minnesota Inc., Minnesota, MN (US)

(72) Inventors: Joseph A. Daniski, Minnetonka, MN (US); Christina M. Wateski, Brooklyn Park, MN (US); Elisa J. McCline, Elk River, MN (US); Christopher C. Wagner, Saint Anthony, MN (US)

(21) Appl. No.: 18/816,761

(22) Filed: Aug. 27, 2024

Related U.S. Application Data
(60) Provisional application No. 63/569,401, filed on Mar. 25, 2024.
(60) Provisional application No. 63/537,319, filed on Sep. 8, 2023.

(51) Int. Cl. B05B 12/08; B05B 12/00

(52) U.S. Cl. CPC B05B 12/087; B05B 12/002

(57) ABSTRACT

A spray gun is configured to emit spray fluid and compressed air that impinges on the spray fluid to atomize the spray fluid. A trigger actuates one or more valves of the spray gun to cause spraying by the spray gun. The trigger is mounted to a gun body of the spray gun by a trigger mount. The trigger is removable from the gun body and includes one or more tool interfaces for connecting and/or disconnecting components of the spray gun.

### CROSS-REFERENCE TO RELATED APPLICATION(S)

This application claims priority to U.S. Provisional Application No. 63/537,319 filed Sep. 8, 2023 and entitled “FLUID SPRAY GUN TRIGGER MOUNTING AND RETENTION,” and claims priority to U.S. Provisional Application No. 63/569,401 filed Mar. 25, 2024 and entitled “FLUID SPRAY GUN COMPONENT MOUNTING AND RETENTION,” the disclosures of which are hereby incorporated by reference in their entireties.

### BACKGROUND

This disclosure relates to spray systems. More specifically, this disclosure relates to spray guns and components thereof for use in spray systems.

Spray guns can be used to spray fluids on surfaces. For example, spray guns can be used to spray a liquid such as paint, lacquer, finishes, and other coatings on furniture, cabinets, appliances, equipment, fabricated components, etc.

Some spray guns utilize compressed gas, such as compressed air, to atomize the spray fluid into a desired spray pattern. Typically, the spray fluid is placed under pressure by a piston, diaphragm, or other positive displacement pump. The pump outputs the spray fluid under pressure to the spray gun, such as through a direct connection or through a flexible hose. The spray gun is used to dispense the spray fluid. The spray gun can be attached to the end of the hose opposite the pump. In this way, the spray gun does not include a pump, but rather releases spray fluid pumped to the spray gun through the hose. The spray gun atomizes the spray fluid under pressure into a spray pattern, which is applied to a surface.

The compressed gas is emitted to assist in atomizing and, in some examples, shaping the fluid spray. The spray guns emit the compressed air through an air cap and the compressed air atomizes the spray fluid and can shape the spray fluid into a desired pattern.

Valves control flows of the spray fluid and the compressed gas for emission from the spray gun. The valves can be actuated to open states by a trigger. The trigger requires removal from the gun body for mounting and dismounting of one or more of the valves, which mounting and dismounting can include manipulating multiple retainers. The one or more valves can be disposed within cartridges that mount to the spray gun. The cartridges require tightening and loosening by a tool, such as a wrench, during installation and removal.

### SUMMARY

According to an aspect of the present disclosure, a spray gun includes a gun body; a gun bore extending within the gun body, the gun bore extending along a spray axis; a body bore extending through the gun body and along a mount axis; a first valve assembly at least partially disposed within the bore, the first valve assembly including a first valve configured to control emission of spray fluid from the spray gun; a trigger mountable to the gun body, the trigger configured to actuate the first valve from a closed state to an open state, wherein the trigger is movable relative to the gun body between an engaged state, in which the trigger is movable to open the first valve, and a disengaged state, in which the trigger is spaced from the first valve assembly such that the first valve assembly can pass axially by the trigger along the spray axis; and a trigger mount configured to mount the trigger to the gun body, the trigger mount actuatable between a retaining state, in which the trigger mount connects the trigger to the gun body and holds the trigger in the engaged state, and a mounting state, in which the trigger is dismountable from the trigger mount and gun body. The trigger mount includes a mount body at least partially disposed within the body bore, the mount body projecting out of the body bore in a first direction along the axis to interface with a first arm of the trigger and the mount body projecting out of the body bore in a second direction along the axis to interface with a second arm of the trigger. The mount body is configured to displace in the second direction along the mount axis to place the trigger mount in the mounting state.

According to an additional or alternative aspect of the present disclosure, a spray gun includes a gun body; a gun bore extending within the gun body, the gun bore extending along a spray axis; a body bore extending through the gun body and along a mount axis; a first valve assembly at least partially disposed within the bore, the first valve assembly including a first valve configured to control emission of spray fluid from the spray gun; a trigger mountable to the gun body, the trigger configured to actuate the first valve from a closed state to an open state, wherein the trigger is movable relative to the gun body between an engaged state, in which the trigger is movable to open the first valve, and a disengaged state, in which the trigger is spaced from the first valve assembly such that the first valve assembly can pass axially by the trigger along the spray axis; and a trigger mount configured to mount the trigger to the gun body, the trigger mount actuatable between a retaining state, in which the trigger mount connects the trigger to the gun body and holds the trigger in the engaged state, and a mounting state, in which the trigger is dismountable from the trigger mount and gun body. The trigger mount includes a mount body at least partially disposed within the body bore and movable relative to the gun body, the mount body configured to displace in a single direction along the mount axis to disengage from a first trigger arm of the trigger and a second trigger arm of the trigger and actuate the trigger mount from the retaining state to the mounting state.

According to another additional or alternative aspect of the present disclosure, a method of assembling a spray gun includes displacing a mount body of a trigger mount in a first direction along a mount axis of a body bore formed in a gun body of the spray gun; passing a trigger by the mount body such that a first pivot head of the mount body is aligned with a first mount opening through a first arm of the trigger and such that a second pivot head of the mount body is aligned with a second mount opening through a second arm of the trigger; and displacing the mount body in a second direction along the mount axis such that the first pivot head enters into the first mount opening and such that the second pivot head enters into the second mount opening.

According to yet another additional or alterative aspect of the present disclosure, a method of disassembling a spray gun includes displacing a mount body of a trigger mount in a first direction along a mount axis of a body bore formed in a gun body of the spray gun such that a first pivot head of the mount body passes out of a first mount opening through a first arm of a trigger of the spray gun and such that a second pivot head of the mount body passes out of a second mount opening through a second arm of the trigger; and passing the trigger by the mount body to dismount the trigger from the gun body.

According to yet another additional or alternative aspect of the disclosure, a trigger for use with a spray gun includes a trigger pull; a first arm extending from thee trigger pull; a second arm extending from the trigger pull; a first mount opening formed through the first arm, the first mount opening including a first trigger bearing surface configured to ride on a pivot of the spray gun during actuation of the trigger; a second mount opening formed through the second arm, the second mount opening including a second trigger bearing surface configured to ride on the pivot of the spray gun during actuation of the trigger; and a tool connector configured to interface with a component of the spray gun to exert a force on the component of the spray gun during one or both of mounting and dismounting of the component.

According to yet another additional or alternative aspect of the disclosure, a method of servicing a spray gun includes disconnecting a trigger from a gun body of the spray gun; interfacing the trigger with a component of the spray gun; and exerting force on the component, by the trigger, to disconnect the component from the spray gun.

According to yet another additional or alternative aspect of the disclosure, a cartridge for a spray gun includes a cartridge body extending along an axis and defining a flow chamber within an interior of the cartridge body; a nozzle formed at a first end of the cartridge body, the nozzle configured to output spray fluid from the flow chamber in a first direction along the axis; at least one fluid port extending through the cartridge body between the exterior of the cartridge body and the flow chamber formed within an interior of the cartridge body; and a first horn slot formed in the cartridge body and a second horn slot formed in the cartridge body, the first horn slot and the second horn slot open in the first direction along the axis.

According to yet another additional or alternative aspect of the disclosure, a method of servicing a spray gun, includes disconnecting an air cap from a gun body of the spray gun; interfacing the air cap with a component of the spray gun; and exerting force on the component, by the air cap, to disconnect the component from the spray gun.

### BRIEF DESCRIPTION OF THE DRAWINGS

FIG. 1 is an isometric view of a spray gun.

FIG. 2A is a cross-sectional view taken along line 2-2 in FIG. 1 showing the spray valve in a closed state.

FIG. 2B is a cross-sectional view taken along line 2-2 in FIG. 1 showing the spray valve in an open state.

FIG. 3A is a partial isometric view from a first lateral side of a spray gun showing the trigger mounted to the gun body.

FIG. 3B is a partial isometric view from a second lateral side of the spray gun showing the trigger mounted to the gun body.

FIG. 3C is a cross-sectional view taken along line C-C in FIG. 3A.

FIG. 4A is a partial isometric view from the first lateral side of the spray gun showing the trigger dismounted from the gun body.

FIG. 4B is a partial isometric view from the second lateral side of the spray gun showing the trigger dismounted from the gun body.

FIG. 4C is a cross-sectional view taken along line C-C in FIG. 4A.

FIG. 5A is a first isometric view of a trigger.

FIG. 5B is a second isometric view of the trigger.

FIG. 5C is a side elevational view of the trigger.

FIG. 6 is an enlarged isometric view of a mounting interface of a trigger on a spray gun.

FIG. 7A is an isometric partially exploded view of a spray gun.

FIG. 7B is an isometric partially exploded view of the spray gun.

FIG. 8 is an isometric view of a trigger and a spray control assembly.

FIG. 9 is an isometric view of a trigger.

FIG. 10 is a partial elevational view showing an air cap and cartridge interface.

FIG. 11A is an isometric view of a cartridge for a spray gun.

FIG. 11B is an elevational end view of spray control assembly.

### DETAILED DESCRIPTION

This disclosure relates to fluid spraying. More specifically, this disclosure relates to component assembly for a spray gun. A trigger is movable between a trigger engaged state, in which the trigger is movable to open a first valve of the spray gun, and a disengaged state, in which the trigger is spaced from the first valve assembly such that the first valve assembly can pass axially by the trigger along a spray axis. A trigger mount engages the trigger to support the trigger on the gun body. The trigger mount is actuatable between a retaining state, in which the trigger mount can hold the trigger on the gun body and in the trigger engaged state, and a mounting state, in which the trigger can be mounted to or dismounted from the gun body.

Spray guns according to the disclosure are configured to emit a spray of spray fluid, such as liquid paints, varnishes, lacquers, fine finishes, high-gloss finishes, waterborne coatings, solvent-borne coatings, etc. The spray gun can be used to apply coatings to surfaces, furniture, cabinets, appliances, equipment, fabricated components, etc., among other options. The spray gun also emits compressed gas. An atomization portion of the compressed gas is configured to atomize spray fluid and complete the atomization of the fan tails, preventing undesired tailing. A shaping portion of the compressed gas is configured to shape the spray pattern. The spray fluid is emitted through a nozzle and the compressed gas is emitted through an air cap surrounding the nozzle. The atomization gas is emitted with each actuation of the spray gun to a spray state while the fan gas can be set by the user between no fan gas and a maximum flow.

According to aspects of the disclosure, the trigger mount includes a mount body that interfaces with the trigger to pivotably support the trigger on the gun body. The mount body is actuatable relative to the trigger to place the trigger mount in the retaining state and the mounting state. The mount body can be actuated by a single input to detach the trigger from the gun body. The mount body can be actuated by a single input to attach the trigger to the gun body. The mount body can shift in a single direction along the axis to connect the trigger to the gun body and in an opposite direction to disconnect the trigger from the gun body.

The trigger can include one or more tool interfaces. The tool interfaces are configured to facilitate connection and disconnection of components of the spray gun. In some examples, the trigger includes a tool interface that is configured to engage with a portion of a valve cartridge to facilitate torquing of the valve cartridge during mounting or dismounting (e.g., to tighten or loosen a threaded interface). In some examples, the tool interface forms a pivot support of the trigger that supports the trigger on the trigger mount during spray operations.

Components can be considered to radially overlap when those components are disposed at common axial locations along an axis. A radial line extending orthogonally from axis will extend through each of the radially overlapping components. Components can be considered to axially overlap when those components are disposed at common radial and circumferential locations relative to the axis. An axial line parallel to the axis will extend through the axially overlapping components. Components can be considered to circumferentially overlap when those components are disposed at common radial distance and axial locations along the axis, such that a circle centered on the axis passes through each of the circumferentially overlapping components.

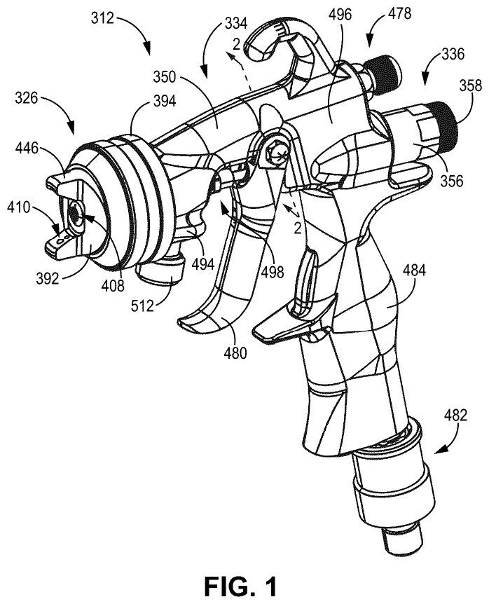

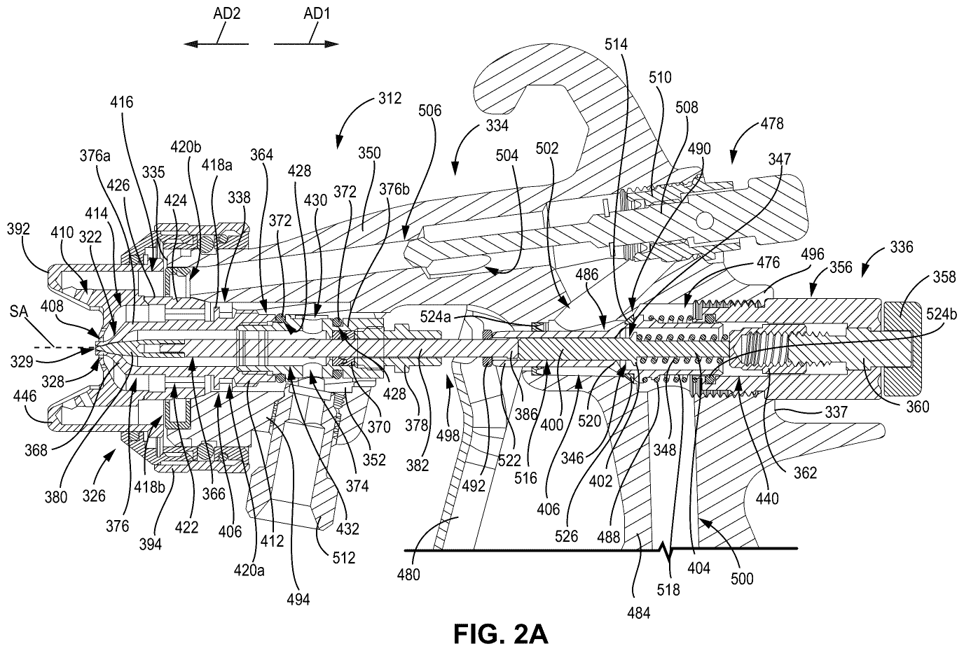

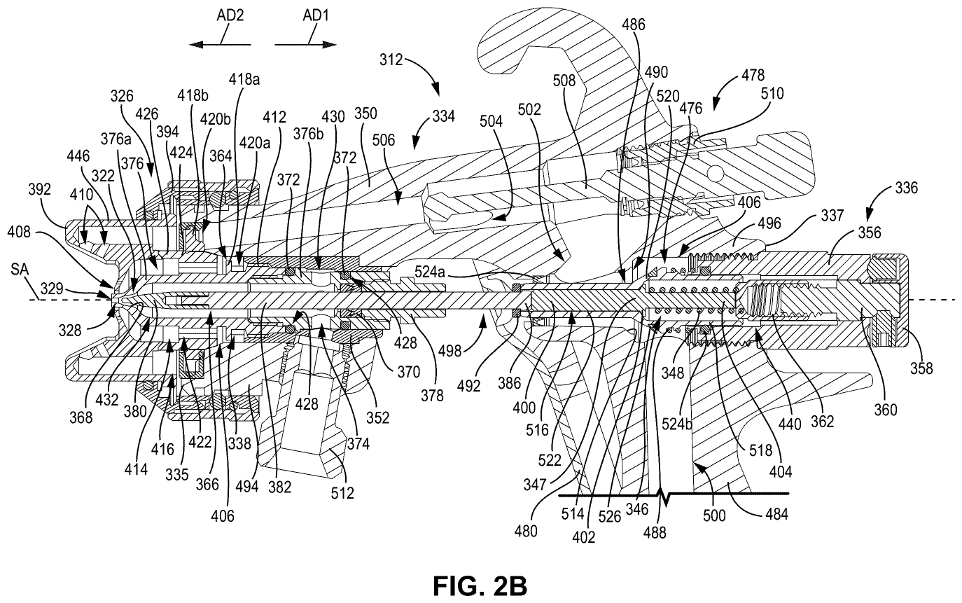

FIG. 1 is an isometric view of spray gun 312. FIG. 1A is a cross-sectional view taken along line 2-2 in FIG. 1 showing the spray valve 322 in a closed state. FIG. 1B is a cross-sectional view taken along line 2-2 in FIG. 1 showing the spray valve 322 in an open state. FIGS. 1-2B will be discussed together. Spray gun 312 is a manual spray gun configured to be held in the hand of a user and activated directly by the user to spray the spray fluid.

Spray gun 312 includes gun body 334, air cap assembly 326, spray control assembly 338, flow control assembly 476, fan valve 478, trigger 480, and metering valve 482. Gun body 334 includes main body 350, gun mount 352, and handle 484. Air cap assembly 326 includes air cap 392 and cap retainer 394. Flow control assembly 476 includes displacement limiter 336, needle return 346, valve seal 486, and valve spring 488. Displacement limiter 336 includes limiter housing 356, knob 358, positioner 360, and stop 362. Needle return 346 includes return block 347 and return spring 348. Spray control assembly 338 includes spray valve 322, nozzle 328, cartridge body 364, needle 366, seat 368, needle seal 370, cartridge seals 372, and fluid ports 374. Cartridge body 364 includes housing 376 and seal holder 378. Housing 376 includes inlet housing 376a and outlet housing 376b. Needle 366 includes needle tip 380, needle body 382, and needle head 386.

The spray gun 312 sprays along a spray axis SA. The axis also represents an upstream side or direction and a downstream side or direction, wherein spray fluid generally flow from the upstream direction towards the downstream direction. In the example shown, the downstream direction is the second axial direction AD2 and the upstream direction is the first axial direction AD1. Spray gun 312 can emit the spray fluid as a fan in some examples.

Spray gun 312 is configured as a manual spray gun that is held in a hand of the user and actuated between spray and non-spray states by the user. The user can grasp handle 484 to aim and manipulate spray gun 312. The user can hold spray gun 312 and actuate spray gun 312 between the spray and non-spray states with a single hand of the user. The user can depress trigger 480 with the fingers of the hand that is grasping handle 484 to actuate spray gun 312 between the spray and non-spray states. Trigger 480 controls actuation of the spray valve 322 and the air valve 490 to respective open states.

Spray gun 312 is configured to receive flows of spray fluid and compressed air and to emit an atomized spray of the spray fluid for application on a target surface. Spray gun 312 is configured as a manual spray gun, though it is understood that not all examples are so limited. Gun body 334 supports other components of spray gun 312.

Main body 350 supports other components of spray gun 312. Main body 350 includes front block 494 and rear block 496. Front block 494 at least partially defines flowpaths for both spray fluid and compressed gas to flow through spray gun 312. Rear block 496 at least partially defines flowpaths for compressed gas to flow through spray gun 312. In the example shown, rear block 496 does not define any passages for spray fluid and is not exposed to spray fluid. Trigger gap 498 is disposed axially between front block 494 and rear block 496. Trigger gap 498 is open towards a bottom side of spray gun 312. Trigger gap 498 is closed by a portion of main body 350 that spans between front block 494 and rear block 496.

Handle 484 extends from main body 350. Handle 484 projects from a lower side of main body 350. Handle 484 extends from rear block 496 of main body 350 in the example shown. Air inlet passage 500 is formed within and through handle 484. Air inlet passage 500 provides a flowpath for compressed gas to enter into gun body 334 and flow to the air passages within main body 350.

Metering valve 482 is mounted to gun body 334. Metering valve 482 is configured to connect to an air hose (such as air hose 32 (FIG. 1)) that supplies compressed air to spray gun 312. Metering valve 482 is mounted handle 484. Metering valve 482 is configured to control flow of compressed air to spray gun 312. Metering valve 482 is actuatable between an open state, in which the compressed air can flow into spray gun 312, and a closed state, in which the compressed air is prevented from flowing into spray gun 312. The metering valve 482 is placed in and maintained in a desired state. The metering valve 482 is not a check valve that is actuated between open and closed states by the flow of the compressed air.

Gun bore 406 extends fully axially though gun body 334. Gun bore 406 is open on both the front end 335 of spray gun 312 and the rear end 337 of spray gun 312. Gun bore 406 extends along spray axis SA. Gun bore 406 extends fully axially through front block 494 such that gun bore 406 is open on both axial sides of front block 494. The portion of gun bore 406 in front block 494 is open on front end 335 and open to trigger gap 498. Gun bore 406 extends fully axially through rear block 496 such that gun bore 406 is open on both axial sides of rear block 496. The portion of gun bore 406 in rear block 496 is open on rear end 337 and open to trigger gap 498.

A portion of gun bore 406 in rear block 496 is directly downstream from air inlet passage 500 and defines a portion of the compressed gas flowpath through gun body 334. Air valve 490 divides the gun bore 406 in rear block 496 into an upstream passage that is fluidly connected to air inlet passage 500 throughout operation and a downstream passage that is fluidly connected to air inlet passage 500 with air valve 490 in the open state and that is fluidly disconnected from air inlet passage 500 with air valve 490 in the closed state.

Common passage 502 extends from the portion of gun bore 406 in rear block 496 and forms a portion of the compressed air flowpath through spray gun 312. Common passage 502 receives compressed air from the gun bore 406 in rear block 496 when the air valve 490 is in the open state. The common passage 502 routes the compressed air to atomization air passage 504 (an inlet of which is shown) and shaping air passage 506. The atomization passage 504 extends to aperture 420a to output the atomization portion of the compressed air proximate baffle 418a. The shaping air passage 506 extends to aperture 420b to output the shaping portion of the compressed air proximate baffle 418b.

Fan valve 478 is mounted to gun body 334. Fan valve 478 is actuatable between an open state, in which shaping air passage 506 is open and fluidly connected to common passage 502 such that the shaping portion of the compressed air can flow to the air cap 392, and a closed state, in which the shaping air passage 506 is fluidly disconnected from the common passage 502 such that the shaping portion of the compressed air is prevented from flowing to the air cap 392. Fan valve 478 includes a fan valve shaft 508 that has a shaft head that is engageable with a seat within gun body 334 to place fan valve 478 in the closed state. The fan valve shaft 508 is accessible from outside of the gun body 334 to be manipulated by the user. In the example shown, the fan valve shaft 508 is mounted to a support housing 510 by a threaded interface, with the support housing 510 mounted to gun body 334. The fan valve shaft 508 is rotated relative to the support housing 510 to displace the fan valve shaft 508 and place the fan valve 478 in the open or closed states. The atomization air passage 504 is fluidly connected to the common passage 502 regardless of the state of the fan valve 478. As such, spray gun 312 is configured to emit atomization air during any spray operation while the shaping air can be turned on or shut off depending on the state of fan valve 478.

Gun mount 352 is disposed within main body 350. In the example shown, gun mount 352 is disposed within front block 494 of main body 350. Gun mount 352 can be press-fit, threaded, or otherwise secured within main body 350. Gun mount 352 at least partially defines the spray fluid pathway through spray gun 312. Gun mount 352 can be considered to form a wet component of spray gun 312 as gun mount 352 is exposed to the spray fluid during operation.

Spray fluid fitting 512 is mounted to gun body 334. Spray fluid fitting 512 is mounted to main body 350 in the example shown. Spray fluid fitting 512 is mounted to front block 494 of main body 350 in the example shown. Spray fluid fitting 512 is configured to connect with a hose (e.g., a fluid hose) that supplies spray fluid to spray gun 312 under pressure. Spray fluid fitting 512 can extend into gun mount 352 and can interface with gun mount 352. Spray fluid fitting 512 does not extend to axially overlap with spray control assembly 338. Spray fluid fitting 512 not axially overlapping with spray control assembly 338 along spray axis SA allows spray control assembly 338 to be shifted into or out of gun bore 406 during mounting and dismounting without the user having to manipulate spray fluid fitting 512, as discussed in more detail below.

Air cap assembly 326 is disposed at a first axial end of gun body 334. Air cap assembly 326 is mounted to front block 494. Air cap 392 is configured to emit both atomizing air and shaping air. Central orifice 408 is formed through air cap 392. Central orifice 408 is disposed on spray axis SA. Central orifice 408 is configured to emit atomization air from air cap 392. Shaping orifices 410 are formed in horns 446 of air cap 392. Shaping orifices 410 are configured to emit shaping air from air cap 392.

Air cap 392 is mounted to gun body 334 by cap retainer 394. Cap retainer 394 extends over air cap 392 and interfaces with gun body 334 to secure air cap 392 to gun body 334. Cap retainer 394 is connected to front block 494 in the example shown. Cap retainer 394 can be mounted to gun body 334 by a quick connect interface though it is understood that other connection types are possible, such as a threaded connection. In the example shown, a portion of cap retainer 394 is configured to shift axially relative to spray axis SA to lock and unlock air cap 392 to gun body 334.

Spray control assembly 338 is configured to control emission of the spray fluid from spray gun 312. Spray control assembly 338 is mounted to gun body 334. In the example shown, spray control assembly 338 is mounted within front block 494 of main body 350. Spray control assembly 338 extends fully axially through front block 494 in the example shown. Spray control assembly 338 projects out of front block 494 in both first axial direction AD1 and second axial direction AD2 in the example shown.

Spray control assembly 338 is at least partially disposed within gun body 334. Spray control assembly 338 forms a fluid cartridge that is mountable to and dismountable from gun body 334 as a unitary assembly. The spray control assembly 338 is a single module that can be inserted into gun bore 406 through the front end 335 and can be removed from the gun bore 406 through front end 335 as the single module.

Cartridge body 364 supports other components of spray control assembly 338. Cartridge body 364 is at least partially disposed within gun body 334. Cartridge body 364 is secured within gun body 334 to secure spray control assembly 338 relative to gun body 334. In the example shown, cartridge body 364 is mounted to gun mount 352 at a location within front block 494. Cartridge body 364 extends into gun mount 352 to interface with gun mount 352. In the example shown, cartridge body 364 extends fully axially through gun mount 352 such that cartridge body 364 projects out of gun mount 352 in both first axial direction AD1 and second axial direction AD2. Cartridge body 364 is connected to gun mount 352 by a threaded interface in the example shown.

Cartridge body 364 includes housing 376 that is configured to interface with a portion of gun body 334 to mount spray control assembly 338 to gun body 334 and cartridge body 364 includes seal holder 378 that mounts to housing 376. Housing 376 and seal holder 378 form the exterior of cartridge body 364. In the example shown, nozzle 328 is formed by housing 376. Nozzle 328 is formed at a first axial end of housing 376 and seal holder 378 is mounted to a second axial end of housing 376 opposite the first axial end of housing 376. Spray fluid is emitted through spray orifice 329. Nozzle 328 extends to spray orifice 329 through which the spray fluid is emitted. Spray orifice 329 is formed at an axial end of spray control assembly 338 in second axial direction AD2.

Cartridge mount 412 is formed on an exterior of cartridge body 364. In the example shown, cartridge mount 412 is formed on housing 376. Cartridge mount 412 is configured to interface with a portion of gun body 334 to secure spray control assembly 338 to gun body 334. In the example shown, cartridge mount 412 is formed by threads on the exterior of outlet housing 376a. Cartridge mount 412 is configured to engage with threading on gun mount 352 to secure spray control assembly 338 to gun body 334.

Housing 376 at least partially defines flowpaths for spray fluid to flow to nozzle 328 and for compressed air to flow to air cap 392. In the example shown, housing 376 is formed from inlet housing 376b and outlet housing 376a mounted together. Inlet housing 376b is configured to receive spray fluid into spray control assembly 338. Outlet housing 376a is configured to emit spray fluid from spray control assembly 338. Inlet housing 376b and outlet housing 376a are connected together to form housing 376. In the example shown, inlet housing 376b and outlet housing 376a are connected together by a threaded interface. In the example shown, inlet housing 376b includes male threading configured to interface with female threading formed on outlet housing 376a. A portion of inlet housing 376b extends into outlet housing 376a to form the threaded interface therebetween.

Baffle 418a extends radially from the exterior of cartridge body 364. Baffle 418a extends radially from housing 376. In the example shown, baffle 418a extends radially from outlet housing 376a. In the example shown, baffle 418a is formed as a flange extending radially outwards from cartridge body 364. Baffle 418a extends annularly about cartridge body 364 in the example shown. Baffle 418a can be integrally formed with other portions of cartridge body 364. In some examples, baffle 418a can be formed monolithically with other portions of cartridge body 364. In the example shown, baffle 418a is monolithic with housing 376. In the example shown, baffle 418a is monolithic with outlet housing 376.

Baffle 418a is configured to distribute a first portion of the compressed air annularly about the spray axis SA as the first portion of the compressed air flows in second axial direction AD2. The first portion of the compressed air forms the atomization air in the example shown. Inner air chamber 414 is configured to route the first portion of the compressed air to the central orifice 408 of air cap 392. The inner air chamber 414 is formed about the spray axis SA. The inner air chamber 414 is disposed about an exterior of the cartridge body 364. In the example shown, a portion of the inner air chamber 414 is radially bracketed by the cartridge body 364 such that a radially outer side of that portion of the inner air chamber 414 is defined by the cartridge body 364 and a radially inner side of that portion of the inner air chamber 414 is defined by the cartridge body 364. The portion of the inner air chamber 414 radially bracketed by cartridge body 364 is a downstream portion of the inner air chamber 414. The inner air chamber 414 is disposed axially between gun mount 352 and central orifice 408. The downstream portion of the inner air chamber 414 is disposed axially between the air passages 422 and central orifice 408.

The atomization portion of the compressed air enters into the inner air chamber 414 through aperture 420a on one axial side of the baffle 418a. The atomization portion of the compressed air flows in second axial direction AD2 over baffle 418a, through air passages 422 in cartridge body 364 and downstream to central orifice 408. The first portion of the compressed air exits spray gun 312 through central orifice 408 in air cap 392. The first portion of the compressed air exits spray gun 312 through an annular ring formed about the portion of the cartridge body 364 defining nozzle 328.

Baffle 418b extends radially from the exterior of cartridge body 364. Baffle 418b extends radially from housing 376. In the example shown, baffle 418b extends radially from outlet housing 376b. In some examples, baffle 418b can be formed separately from housing 376 and mounted to housing 376. In some examples, baffle 418b can be integrally formed with other portions of cartridge body 364. In some examples, baffle 418b can be formed monolithically with other portions of cartridge body 364. It is understood, however, that not all examples are so limited. For example, baffle 418b can be formed separately from housing 376 and be mounted within front block 494 such that spray control assembly 338 shifts relative to the baffle 418b during mounting and dismounting. Baffle 418b can be mounted within gun body 334 such that baffle 418b does not mount to and dismount from gun body 334 with spray control assembly 338.

Baffle 418b is configured to distribute a second portion of the compressed air annularly about the spray axis SA as the second portion of the compressed air flows in second axial direction AD2. The second portion of the compressed air forms the shaping air in the example shown. An outer air chamber 416 is configured to route the second portion of the compressed air to the shaping orifices 410. The outer air chamber 416 is formed about the spray axis SA. The outer air chamber 416 is disposed about an exterior of the cartridge body 364. In the example shown, a portion of the outer air chamber 416 radially overlaps with a portion of the inner air chamber 414. The outer air chamber 416 is disposed radially outward of the inner air chamber 414.

The shaping portion of the compressed air enters into the outer air chamber 416 through aperture 420b on one axial side of the baffle 418b. The shaping portion of the compressed air is distributed about the spray axis SA by baffle 418b and flows in second axial direction AD2 and downstream to shaping orifices 410. The shaping portion of the compressed air exits spray gun 312 through shaping orifices 410 in air cap 392.

Collar 424 is formed on outlet housing 376b. Collar 424 extends radially outward relative to other portions of outlet housing 376b. Collar 424 is disposed axially between nozzle 328 and baffle 418a. Collar 424 can extend fully annularly about the spray axis SA.

Air passages 422 extend through collar 424. Air passages 422 are configured to route the atomization portion of the compressed air from an upstream portion of the inner air chamber 414 to the downstream portion of the inner air chamber 414. In the example shown, a plurality of air passages 422 are formed through collar 424. An array of the air passages 422 can be disposed annularly about the spray axis SA.

Ring 426 projects in second axial direction AD2 from a main body portion of collar 424 through which air passages 422 are formed. Ring 426 is disposed radially between inner air chamber 414 and outer air chamber 416. Ring 426 projects to engage with an axially inner side of air cap 392, sealing with air cap 392 to fluidly separate inner air passage 414 and outer air passage 416. Ring 426 defines portions of inner air chamber 414 and outer air chamber 416 in the example shown. The portion of inner air chamber 414 radially bracketed by cartridge body 364 is disposed radially between ring 426 and outlet housing 376a.

Cartridge seals 372 are disposed between cartridge body 364 and gun body 334. Cartridge seals 372 fluidly separate wet portions and dry portions within gun body 334. In the example shown, cartridge seals 372 are disposed on the exterior of cartridge body 364. In the example shown, cartridge seals 372 are disposed between and engage with cartridge body 364 and gun mount 352. Cartridge seals 372 axially bracket the portion of the spray fluid flowpath outside of cartridge body 364 and inside of gun mount 352.

In the example shown, seal grooves 428 are formed on cartridge body 364. Cartridge seals 372 are disposed in seal grooves 428 such that cartridge seals 372 are mounted on cartridge body 364. A first one of seal grooves 428 is disposed axially between nozzle 328 and fluid ports 374. A second one of seal grooves 428 is disposed axially between fluid ports 374 and trigger gap 498.

Fluid passage 430 is disposed axially between the cartridge seals 372. The fluid passage 430 extends fully annularly about cartridge body 364. The fluid passage 430 defines an annular flowpath for the spray fluid to flow fully about cartridge body 364 to enter into fluid ports 374 to enter into flow chamber 432. The fluid passage 430 facilitates spray fluid entering into flow chamber 432 from locations disposed circumferentially about cartridge body 364 and spray axis SA. The flowpath from fluid passage 430 through fluid ports 374 and into flow chamber 432 does not restrict flow relative to outflow through nozzle 328, facilitating efficient and effective output of spray fluid for atomization during spray operations.

Fluid ports 374 are formed through cartridge body 364. Fluid ports 374 form flowpaths for the spray fluid to enter into flow chamber 432 within cartridge body 364. In the example shown, multiple fluid ports 374 are arrayed about the cartridge body 364. Each fluid port 374 includes an outer opening on the exterior of cartridge body 364 that allow spray fluid to enter into the fluid port 374 from fluid passage 430 and includes an inner opening that opens into flow chamber 432 and allows the spray fluid to enter into flow chamber 432. The fluid ports 374 are disposed axially between the cartridge seals 372. The fluid ports 374 are spaced in first axial direction AD1 from cartridge mount 412. The fluid ports 374 are disposed on an opposite axial side of the mating interface between cartridge body 364 and gun body 334 from nozzle 328.

Seal holder 378 is connected to housing 376. In the example shown, seal holder 378 is mounted to housing 376 by a threaded interface formed therebetween. Seal holder 378 is disposed at an opposite axial end of housing 376 from nozzle 328. Seal holder 378 extends into housing 376 to radially overlap with housing 376. Seal holder 378 is configured to interface with needle seal 370 to retain needle seal 370 within cartridge body 364.

Needle seal 370 is configured to interface with an exterior of needle 366. Needle seal 370 can be considered to form a dynamic seal as needle 366 shifts axially relative to needle seal 370 during operation. Needle seal 370 can be formed as a seal assembly including multiple individual sealing components. Needle seal 370 is disposed in the interior of cartridge body 364. The flow chamber 432 of spray control assembly 338 extends axially between nozzle 328 and needle seal 370. Needle seal 370 forms a sliding seal with the exterior of needle 366 as needle 366 shifts between open and closed states. Needle seal 370 engages with the exterior of needle 366 to inhibit spray fluid from leaking in first axial direction AD1 and out of cartridge body 364.

Spray valve 322 is formed between needle 366 and seat 368. Seat 368 is formed by cartridge body 364, in the example shown. Needle 366 is engaged with seat 368 with spray valve 322 in the closed state and needle 366 is disengaged from seat 368 with spray valve 322 in the open state. Needle 366 is configured as the movable component of spray valve 322.

Needle 366 is at least partially disposed within cartridge body 364. Needle 366 is configured to shift along spray axis SA to actuate spray valve 322 between open and closed states. Needle 366 is movable along spray axis SA and relative to seat 368 to place spray valve 322 in the open and closed states.

Needle tip 380 is configured to engage with seat 368 to place spray valve 322 in the closed state. Needle tip 380 is disposed at one axial end of needle 366. Needle body 382 extends axially from needle tip 380. In the example shown, needle tip 380 is formed separately from needle body 382 and connected to needle body 382, such as by a threaded interface. It is understood, however, that not all examples are so limited. For example, needle tip 380 and needle body 382 can be formed monolithically.

Needle body 382 extends in first axial direction AD1 from needle tip 380. Needle body 382 extends from within flow chamber 432 to outside of cartridge body 364. Needle body 382 extends through needle seal 370 and engages with needle seal 370. Needle body 382 engaging with needle seal 370 seals an axial end of flow chamber 432.

Needle head 386 is disposed at an opposite axial end of needle body 382 from needle tip 380. Needle head 386 has a larger diameter than needle body 382. In the example shown, the needle 366 can be considered to have a needle neck that is the same diameter as the needle body 382.

Coupler 492 is mounted on needle body 382. Coupler 492 is disposed on needle body 382 between needle head 386 and cartridge body 364. Coupler 492 is disposed outside of cartridge body 364. Coupler 492 rides on needle body 382 and is not fixed to needle body 382 such that coupler 492 can slide axially along needle body 382 relative to needle body 382. The opening through coupler 492 is sized such that needle head 386 cannot pass through coupler 492.

Coupler 492 is disposed on an opposite side of trigger 480 from cartridge body 364. Coupler 492 is sized such that trigger 480 cannot pass over coupler 492 as trigger 480 is actuated to cause spraying by spray gun 312. Instead, trigger 480 interfaces with coupler 492 such that trigger 480 can displace coupler 492 in first axial direction AD1. Trigger 480 displaces coupler 492 to cause coupler 492 to engage with needle head 386 and then drive needle 366 in first axial direction AD1 to actuate spray valve 322 to the open state. While spray control assembly 338 is described as including coupler 492, it is understood that not all examples are so limited.

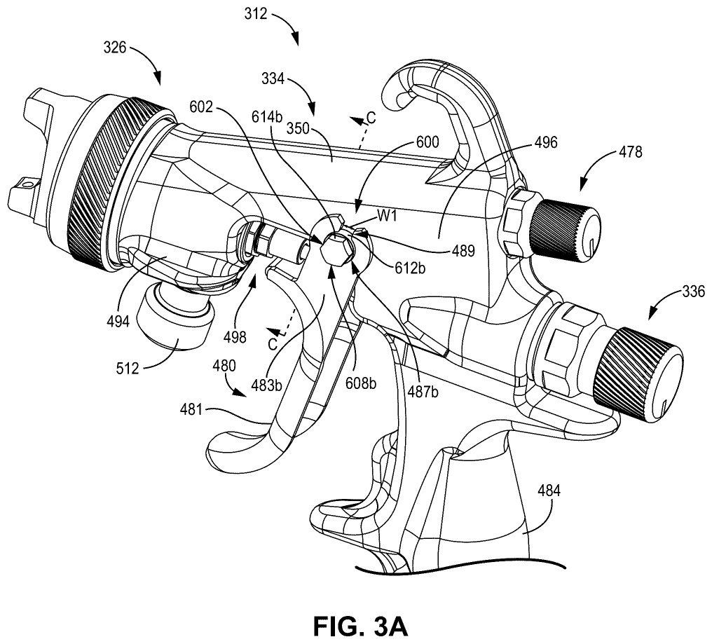

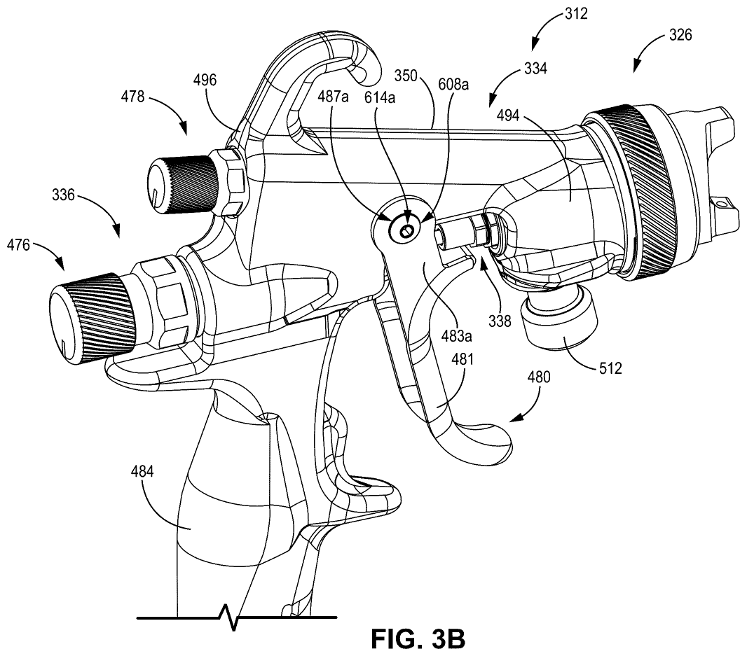

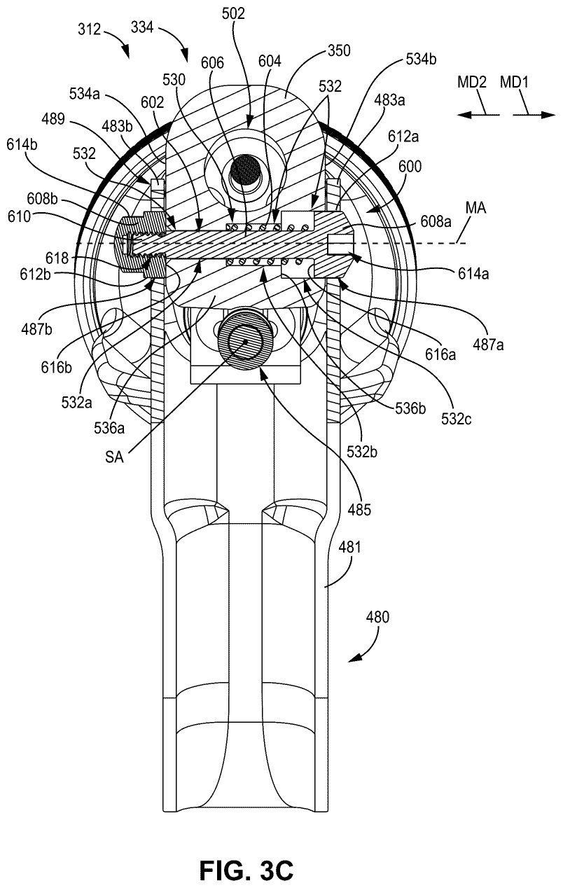

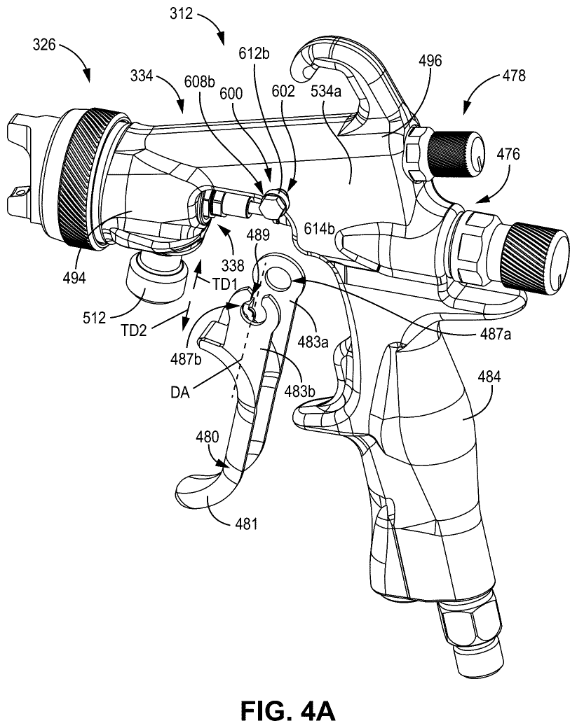

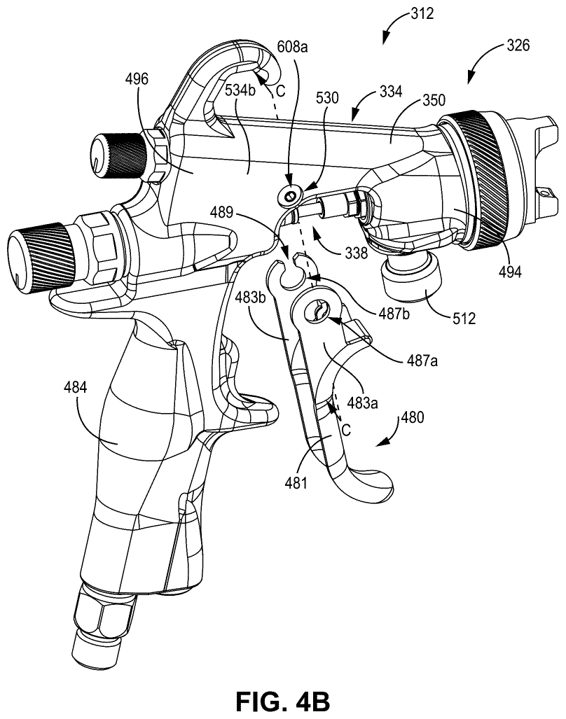

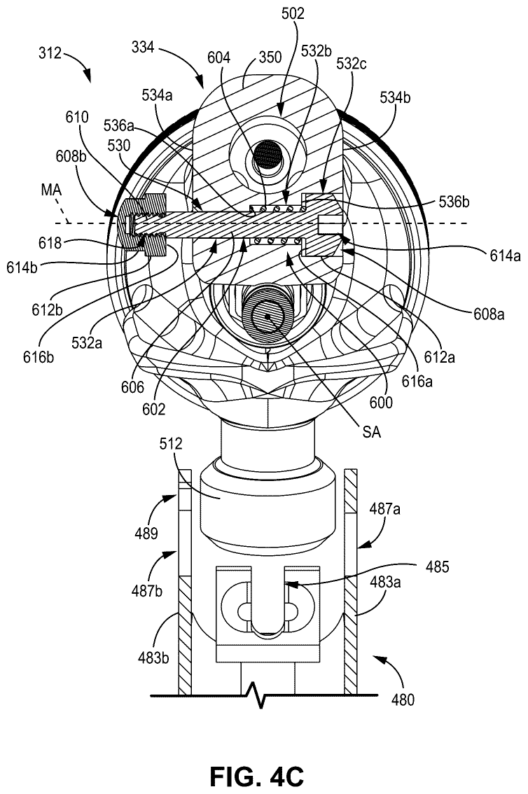

Trigger 480 is mounted on gun body 334 by trigger mount 600. Trigger mount 600 can be actuated relative to gun body 334 to connect trigger 480 to gun body 334 and to disconnect trigger 480 from gun body 334. Trigger mount 600 is discussed in more detail below with regard to FIGS. 3A-4C.

Flow control assembly 476 is configured to control flow of compressed air through spray gun 312. Flow control assembly 476 includes sealing components that are configured to shift along spray axis SA to actuate air valve 490 between an open state, in which the compressed air can flow through air valve 490 and downstream to air cap 392, and a closed state, in which the compressed air is prevented from flowing downstream to air cap 392. In the example shown, valve seal 486 forms the movable valving component of air valve 490. Air valve 490 is formed between flow control assembly 476 and gun body 334 in the example shown. In the example shown, the air seat 514 that the movable valve member of air valve 490 engages is formed by gun body 334. It is understood, however, that not all examples are so limited. For example, flow control assembly 476 can include a housing that forms the air seat 514 of air valve 490 such that both the seat and the movable valving member that define air valve 490 are formed as components of flow control assembly 476.

Flow control assembly 476 is also configured to manage flow of the spray fluid through spray gun 312, though flow control assembly 476 is a dry component that does not contact the spray fluid. Flow control assembly 476 manages the flow of the spray fluid by limiting a displacement distance of the needle 366 in first axial direction AD1. Flow control assembly 476 thereby sets the distance that needle 366 can displace from seat 368, thereby setting the opening size of spray valve 322. Flow control assembly 476 also manages the flow of the spray fluid by actuating the spray valve 322 from the open state to the closed state.

Flow control assembly 476 is disposed coaxially with spray control assembly 338. Flow control assembly 476 is elongate along spray axis SA. Flow control assembly 476 is mounted to gun body 334. In the example shown, flow control assembly 476 is mounted within rear block 496 of gun body 334. In the example shown, flow control assembly 476 is mounted directly to rear block 496. Flow control assembly 476 is mounted to gun body 334 by a threaded interface in the example shown, though it is understood that other connection types are possible.

Flow control assembly 476 extends fully axially through the portion of the gun bore 406 formed in rear block 496. Flow control assembly 476 is mounted to rear block 496 such that flow control assembly 476 projects out of rear block 496 in both first axial direction AD1 and second axial direction AD2. Flow control assembly 476 projects out of rear end 337 of spray gun 312. A portion of flow control assembly 476 projects into trigger gap 498 formed between front block 494 and rear block 496.

Flow control assembly 476 is configured to mount to spray gun 312 as a single unitary component. Flow control assembly 476 forms a flow cartridge that is mountable and dismountable as a single module. The single module is mountable through rear end 337 and dismountable through rear end 337. Flow control assembly 476 and spray control assembly 338 mount in opposite axial directions and dismount in opposite axial directions. The spray control assembly 338 shifts in first axial direction AD1 during mounting and the flow control assembly 476 shifts in first axial direction AD1 during dismounting. The flow control assembly 476 shifts in second axial direction AD2 during mounting and the spray control assembly 338 shifts in second axial direction AD2 during dismounting. The spray control assembly 338 and flow control assembly 476 shift axially towards each other during mounting and shift axially away from each other during dismounting.

Displacement limiter 336 forms a portion of flow control assembly 476. Displacement limiter 336 is mounted to gun body 334. Displacement limiter 336 is mounted to rear block 496 at a location within rear block 496. Displacement limiter 336 is disposed at an opposite axial end of spray gun 312 from nozzle 328. In the example shown, displacement limiter 336 mounts to gun body 334 to secure other components of flow control assembly 476 to gun body 334. The interface between displacement limiter 336 and gun body 334 fixes flow control assembly 476 along spray axis SA. The interface between displacement limiter 336 and gun body 334 is the only mechanical connection that holds flow control assembly 476 to gun body 334 in the example shown.

Limiter housing 356 is mounted to gun body 334. In the example shown, limiter housing 356 is mounted to rear block 496 of gun body 334. Limiter housing 356 is disposed partially within gun body 334 and partially outside of gun body 334. Limiter bore 440 extends axially through limiter housing 356. Limiter bore 440 is disposed coaxially on spray axis SA. In the example shown, limiter bore 440 extends fully axially through limiter housing 356.

Positioner 360 is at least partially disposed within limiter housing 356. Stop 362 is mounted to positioner 360. In the example shown, positioner 360 includes exterior threads that engage with interior threads formed on stop 362. Stop 362 is at least partially disposed within limiter bore 440. Stop 362 is keyed to limiter housing 356 such that stop 362 does not rotate on spray axis SA. For example, at least a portion of the limiter bore 440 can include a non-circular cross-section taken in a plane normal to the spray axis SA and an exterior surface of the stop 362 can be of the same cross-sectional shape as the surface of the limiter bore 440. In some examples, the exterior of stop 362 can be faceted and the limiter bore 440 can be similarly faceted to mate with the stop 362. The stop 362 and limiter bore 440 can be hexed, among other options. The keyed interface prevents stop 362 from rotating on spray axis SA due to rotation of positioner 360. Instead, rotation of positioner 360 causes stop 362 to displace axially along spray axis SA due to the threaded interface between positioner 360 and stop 362.

Stop 362 is configured to interface with needle return 346 to limit displacement of needle return 346, and thus of needle 366, in second axial direction AD2. Stop 362 is configured to define a maximum opening distance of spray valve 322. Stop 362 defines the maximum distance that needle 366 can shift away from seat 368 and relative to seat 368 to open spray valve 322.

Knob 358 is mounted on positioner 360. Knob 358 is fixed to positioner 360 such that rotation of knob 358 causes rotation of positioner 360. Knob 358 is disposed outside of gun body 334. Knob 358 is disposed outside of limiter housing 356. Knob 358 is accessible by a user such that the user can manipulate knob 358 to rotate positioner 360 and displace stop 362 to adjust the maximum opening distance.

Needle return 346 is disposed within gun body 334. Needle return 346 is disposed at least partially within the interior of flow control assembly 476. Needle return 346 is disposed coaxially with displacement limiter 336 in the example shown. Needle return 346 is disposed at least partially within limiter bore 440 in the example shown. Return block 347 extends axially into limiter bore 440 of limiter housing 356. Needle return 346 is configured to interface with needle 366 and bias needle 366 in second axial direction AD2 and into engagement with seat 368.

Return block 347 is a portion of needle return 346 that interfaces with needle 366. Return block 347 is movable along the spray axis SA. Return block 347 is independent of and not connected to valve seal 486. Valve seal 486 and return block 347 can move relative to each other along spray axis SA.

Return rod 400 of return block 347 extends in second axial direction AD2 and is at least partially disposed in needle bore 516 of valve seal 486. Return rod 400 is configured to abut and engage with needle 366. In the example shown, return rod 400 engages with needle head 386. Return rod 400 abuts needle head 386 but is not fixed to needle head 386 in the example shown. Return rod 400 interfaces with a face of needle head 386 oriented in first axial direction AD1.

Return flange 402 extends radially outward from an exterior of return block 347. Return flange 402 provides a bearing surface for return spring 348 to engage with. Return body 404 forms a portion of needle return 346 extending in first axial direction AD1 from return flange 402. Return body 404 is disposed within return spring 348 and can assist in aligning return spring 348 relative to needle return 346. Return body 404 can be considered to form a spring guide that assists in aligning return spring 348 on spray axis SA.

Return spring 348 is disposed within gun body 334 and engages with return block 347. Return spring 348 is disposed within an interior of flow control assembly 476 such that return spring 348 is isolated from and not exposed to the compressed air flowing through spray gun 312, in the example shown. Return spring 348 is disposed radially within valve seal 486 and extends into limiter bore 440 in the example shown. In the example shown, return spring 348 engages with return flange 402 of return block 347. Return spring 348 also engages with displacement limiter 336. In the example shown, return spring 348 braces on stop 362. Return spring 348 is configured to bias return block 347, and thus needle 366 due to the engagement of return rod 400 and needle head 386, in second axial direction AD2. Return spring 348 is configured to bias needle 366 into engagement with seat 368 to place spray valve 322 in the closed state.

Return spring 348 is disposed outside of the flowpath of the spray fluid through spray gun 312. Return spring 348 is a dry component that is not exposed to the spray fluid during operation. Spray control assembly 338 does not include any springs in the flow chamber 432. In the example shown, the spray control assembly 338 does not include any springs that are part of the spray control assembly 338. Spray control assembly 338 is mountable and dismountable as a single module that does not include any springs. The only spring that exerts a biasing force on needle 366 is return spring 348, which does not directly interface with needle 366. Instead, the return spring 348 is indirectly connected to the needle 366 via the intermediate needle return 346. The return spring 348 exerts a biasing force on needle return 346 and needle return 346 exerts a biasing force on needle 366. The needle 366 is a portion of a first module mountable to the gun body 334 and the return spring 348 is a portion of a second module mountable to the gun body 334.

Valve seal 486 is at least partially disposed within gun body 334. Valve seal 486 is elongate along spray axis SA. Valve seal 486 is hollow in the example shown such that a passage extends fully axially through valve seal 486. The passage is open in both the first axial direction AD1 into an interior of valve seal 486 and in second axial direction AD2 towards nozzle 328. Valve seal 486 includes seal body 518, seal shoulder 520, and valve shaft 522.

Valve shaft 522 is elongate along spray axis SA. Valve shaft 522 is formed as cylinder in the example shown, though it is understood that not all examples are so limited. Valve shaft 522 projects axially out of gun bore 406 and into trigger gap 498 in the example shown. Valve shaft 522 extends through and engages with air seal 524a. Valve shaft 522 forms a sliding seal with air seal 524a as valve shaft 522 can slide axially relative to air seal 524a. Air seal 524a is supported by rear block 496 in the example shown. Air seal 524a is formed as a U-cup seal in this example shown, though it is understood that not all examples are so limited. The sealed interface between air seal 524a and valve shaft 522 prevents compressed air from leaking out of rear block 496 in second axial direction AD2.

Valve seal 486 retains needle return 346 within the interior of flow control assembly 476. The diameter of the needle bore 516 through valve shaft 522 is smaller than the diameter of return flange 402 of needle return 346. The return flange 402 will interface with the interior side of seal shoulder 520 to prevent further movement of needle return 346 in second axial direction AD2, retaining return block 347 in the interior of flow control assembly 476.

Needle 366 and needle return 346 interface at a location within valve seal 486. Specifically, needle 366 and return block 347 interface at a location within valve shaft 522. Needle 366 and return block 347 interface within needle bore 516. Valve shaft 522 can locate both return block 347 and needle 366 on spray axis SA to maintain concentricity therebetween. Maintaining the axial alignment between return block 347 and needle 366 reduces wear on needle 366 by driving needle 366 on axis SA, preventing wear to needle 366 or seat 368 that can occur due to non-coaxial engagement therebetween.

Seal shoulder 520 extends between and connects valve shaft 522 and seal body 518. Seal shoulder 520 extends radially outward between valve shaft 522 and seal body 518. A diameter of valve seal 486 enlarges along seal shoulder 520 between valve shaft 522 and seal body 518. In the example shown, seal shoulder 520 is sloped between valve shaft 522 and seal body 518 such that seal shoulder 520 extends both axially and radially between valve shaft 522 and seal body 518.

Seal body 518 extends in first axial direction AD1 from seal shoulder 520. Seal body 518 extends from seal shoulder 520 and into limiter housing 356. Seal body 518 has a larger diameter than valve shaft 522 in the example shown. Seal body 518 is cylindrical in the example shown, though it is understood that not all examples are so limited.

Seal body 518 extends into limiter housing 356 and engages with air seal 524b. Air seal 524b engages with an exterior surface of seal body 518. Air seal 524b is supported by limiter housing 356 in the example shown. Air seal 524b engaging with seal body 518 and limiter housing 356 inhibits leakage of compressed air therebetween in first axial direction AD1. Air seal 524b seals an interior of flow control assembly 476 and prevents compressed air from flowing into the interior of flow control assembly 476.

Valve seal 486 engages with air seat 514 with air valve 490 in the closed state and is disengaged from air seat 514 with air valve 490 in the open state. In the example shown, flow seal 526, which is supported by valve seal 486, is configured to directly interface with the air seat 514 to place air valve 490 in the closed state. Flow seal 526 is supported by seal shoulder 520 in the example shown. Flow seal 526 is formed separately from valve seal 486 and mounted on valve seal 486 in the example shown. Flow seal 526 is configured to engage with air seat 514 to place air valve 490 in a closed state. Flow seal 526 is spaced from air seat 514 with air valve 490 in an open state. While flow control assembly 476 is described as including flow seal 526, it is understood that not all examples are so limited. For example, valve seal 486 can be configured to directly interface with air seat 514 to place air valve 490 in the closed state.

Valve spring 488 interfaces with valve seal 486 and biases air valve 490 to the closed state. Valve spring 488 biases valve seal 486 in second axial direction AD2 and into engagement with air seat 514. Valve spring 488 extends axially between limiter housing 356 and valve seal 486. In the example shown, seal body 518 of valve seal 486 is disposed radially within valve spring 488 and extends through valve spring 488. Valve spring 488 is disposed on an exterior of flow control assembly 476. Valve spring 488 is disposed such that valve spring 488 is exposed to the airflow through spray gun 312.

Valve spring 488 is configured to bias air valve 490 to the closed state. Return spring 348 is configured to bias spray valve 322 to the closed state. Both valve spring 488 and return spring 348 are disposed within rear block 496 in the example shown. Valve spring 488 and return spring 348 are both formed as dry components that are not exposed to the spray fluid flowing through spray gun 312. Valve spring 488 and return spring 348 are disposed coaxially on spray axis SA. Valve spring 488 and return spring 348 radially overlap with each other. Valve spring 488 is disposed radially outward of return spring 348.

During operation, compressed air is provided to spray gun 312 through air inlet passage 500 and spray fluid is provided to spray gun 312 through spray fluid fitting 512. The spray valve 322 and the air valve 490 are normally in respective closed states. The compressed air flows through air inlet passage 500 and into the gun bore 406 in rear block 496. The valve seal 486 is maintained in engagement with the air seat 514 by valve spring 488 exerting an axial biasing force on valve seal 486 in second axial direction AD2 such that the air valve 490 is in the closed state, preventing flow of compressed air in second axial direction AD1 past air valve 490. The spray fluid flows through spray fluid fitting 512 and enters into fluid passage 430. The spray fluid flows through fluid ports 374 and enters into flow chamber 432 in the interior of spray control assembly 338. The needle 366 is maintained in engagement with seat 368 by return spring 348 exerting a force in second axial direction AD2 on needle return 346 and needle return 346 exerting a force on needle 366 in second axial direction AD2 to bias needle 366 into engagement with seat 368. The spray valve 322 is thus in the closed state, preventing flow of the spray fluid through nozzle 328.

To cause spraying the user depresses trigger 480. The trigger 480 shifts in first axial direction AD1 and engages with coupler 492. For example, the trigger can pivot on a pivot point through the gun body 334. The coupler 492 exerts an axial driving force on valve seal 486 at valve shaft 522. The force of valve spring 488 is overcome and valve seal 486 displaces in first axial direction AD1. Valve seal 486 disengages from air seat 514 and a flowpath is opened between valve seal 486 and air seat 514. Valve spring 488 is compressed between valve seal 486 and limiter housing 356. Air valve 490 is thus in the open state.

With air valve 490 in the open state, the compressed air flows through the air valve 490 and downstream to the common passage 502. The compressed air flows through common passage 502 and to the atomization passage 504 and shaping air passage 506. The atomization portion of the compressed air flows through the atomization passage 504 and out through central orifice 408 in air cap 392. The shaping portion of the compressed air flows through shaping air passage 506 if fan valve 478 is in the open state. With fan valve 478 in the open state the shaping portion of the compressed air flows downstream through shaping air passage 506 and exits from air cap 392 through shaping orifices 410.

The atomization portion of the compressed air flows through atomization passage 504 and to the portion of gun bore 406 in front block 494. The atomization air enters into inner air chamber 414 through aperture 420a. The atomization air encounters baffle 418a, which interrupts the flow and distributes the flow of the atomization air around the spray axis SA. The atomization air continues over baffle 418a and flows through air passages 422 in second axial direction AD2. The atomization air exits air passages 422 and flows through the downstream portion of inner air chamber 414 to central orifice 408. The atomization air exits from central orifice 408 as a ring about nozzle 328.

The shaping portion of the compressed air flows through shaping air passage 506 and encounters baffle 418b. Baffle 418b interrupts the flow of the shaping portion and the distributes the shaping portion about the spray axis SA. The shaping air flows through outer air chamber 416 and to air cap 392. The shaping air exits from shaping orifices 410 in air cap 392.

Air valve 490 shifts to the open state prior to spray valve 322 shifting to the open state. The flow control assembly 476 is configured such that valve seal 486 displaces axially before needle 366 is engaged to displace axially. The air valve 490 shifting to the open state prior to the spray valve 322 shifting to the open state causes the spray gun 312 to emit compressed air from air cap 392 prior to spray gun 312 emitting spray fluid through nozzle 328. The spray gun 312 emitting the compressed air prior to emitting the spray fluid ensures that the atomization air will impact and atomize the spray fluid, preventing sputtering and spitting of the spray fluid that could otherwise occur.

In the example shown, needle head 386 is recessed within valve shaft 522 in first axial direction AD1 such that the coupler 492 contacts the valve seal 486 prior to encountering the needle head 386. As such, the trigger encounters and displaces the valve seal 486 prior to encountering and displacing the needle 366. In examples in which the spray gun 312 includes a valve lock, the valve lock is positioned such that the valve seal 486 displaces axially prior to the needle detents encountering and engaging needle head 386 to displace needle 366, ensuring emission of atomization air prior to emission of spray fluid.

Trigger 480 continues to displace and coupler 492 (in some examples a valve lock) encounters needle head 386 and exerts an axial driving force on needle 366 in first axial direction AD1. The needle 366 encounters return block 347 and exerts an axial driving force on return block 347. The force of return spring 348 is overcome and needle 366 and needle return 346 displace in first axial direction AD1. Return spring 348 is compressed between needle return 346 and stop 362. The needle 366 disengages from seat 368. Spray valve 322 is thereby placed in the open state.

In some examples, valve seal 486 can assist in displacement of the spray valve 322 to the open state. Flow control assembly 476 can be configured such that the interior side of seal shoulder 520 engages with the sloped face of return flange 402 oriented in second axial direction AD2. The valve seal 486 can engage with return flange 402 at the same time as the coupler 492 engages with needle head 386. The coupler 492 can thereby exert driving force on needle 366 at needle head 386 and can exert driving force on needle return 346 through valve seal 486.

Displacement of needle 366 in first axial direction AD1 can be limited by stop 362. Stop 362 can be disposed on spray axis SA and positioned such that return block 347 encounters stop 362 prior to needle 366 shifting a full possible displacement distance in first axial direction AD1. The stop 362 provides a hard stop that limits further axial displacement of return block 347 and needle 366. The trigger 480 is preventing from being further displaced by the return block 347 encountering the stop 362.

With spray valve 322 in the open state, the spray fluid flows through the gap between needle tip 380 and seat 368. The spray fluid flows downstream through nozzle 328 and is emitted from spray gun 312. The atomization air exiting through central orifice 408 impinges on and atomizes the spray fluid exiting from nozzle 328. The shaping air encounters the atomized spray fluid and shapes the atomized spray fluid into a desired pattern.

To stop spraying the user releases the trigger 480. The air valve 490 and spray valve 322 are independent such that air valve 490 is actuated to the closed state independent of the spray valve 322 being actuated to the closed state. Similarly, the air valve 490 and spray valve 322 are independently actuated to respective open states.

Valve spring 488 exerts biasing force on valve seal 486 in second axial direction AD2 and displaces valve seal 486 in second axial direction AD2. Return spring 348 exerts biasing force on return block 347 in second axial direction AD2 and displaces needle return 346 in second axial direction AD2. The needle return 346 exerts a biasing force on needle 366 and displaces needle 366 in second axial direction AD2 until needle 366 engages with seat 368 such that spray valve 322 is in the closed state.

As discussed above, spray gun 312 is configured such that air valve 490 opens prior to spray valve 322 opening. The valve seal 486 displaces a first distance along spray axis SA in first axial direction AD1 prior to needle 366 beginning to shift in first axial direction AD1. Both the valve seal 486 and needle 366 shift together along the spray axis SA a second axial distance. The total displacement of the needle 366 is the second axial distance and the total displacement of the valve seal 486 is a third axial distance, which is a sum of the first axial distance and the second axial distance. The third axial distance is greater than the second axial distance.

Valve seal 486 then needs to displace the third axial distance back to closed while the needle 366 needs to displace the shorter second axial distance back to closed. The spray valve 322 can shift to the closed state prior to the air valve 490 shifting to the closed state. The spray valve 322 closing prior to the air valve 490 closing causes the spray gun 312 to stop emitting spray fluid prior to the spray gun 312 stopping emission of the compressed air. The spray gun 312 continuing to emit the compressed air up to and after the spray gun 312 stops emitting spray fluid prevents sputtering and spitting of the spray fluid at the end of spraying. Atomization air is emitted prior to, during, and after emission of the spray fluid, providing a high quality spray for the duration of spray fluid emission from spray control assembly 338.

Spray gun 312 provides significant advantages. Spray control assembly 338 is mountable as a single, unitary component. Spray control assembly 338 can be mounted and dismounted through front end 335 of spray gun 312. The user does not have to access other components spaced in first axial direction AD1 from spray control assembly 338 to make or break the driving connection that actuates needle 366 during operation. Instead, the user can simply and easily access spray control assembly 338 at front end 335. With the air cap 392 dismounted and trigger 480 shifted to not block movement of coupler 492 in second axial direction AD2, only the cartridge housing 376 needs to be manipulated to install or remove the spray control assembly 338. The spray fluid fitting 512 does not need to be manipulated for mounting or dismounting of spray control assembly 338 as the spray fluid fitting 512 does not extend to interfere with axial movement of the spray control assembly 338.

Spray control assembly 338 does not include any springs that bias needle 366. Needle 366 is actuated to engage seat 368 to place spray valve 322 in the closed state by return spring 348 that is disposed in rear block 496 and does not directly interface with needle 366. No spring is disposed in the spray fluid pathway or exposed to the spray fluid. No springs are disposed in front block 494 to actuate needle 366. Isolating springs from the wet portions of spray gun 312 prevents material accumulation on any such spring that could cause the spring to stick or otherwise lead to required maintenance.

Flow control assembly 476 is mountable to and dismountable from spray gun 312 as a single, unitary component. Flow control assembly 476 is a single module that can be mounted to and dismounted through rear end 337 of spray gun 312. The flow control assembly 476 both controls flow of compressed air and affects operation of the spray valve 322. The flow control assembly sets the distance that needle 366 can space from the seat 368 thereby controlling an opening size of spray valve 322, via displacement limiter 336. The flow control assembly 476 also actuates the spray valve 322 from the open state to the closed state. The air valve 490 and spray valve 322 are independently actuated to the closed state by components of the flow control assembly 476.

FIG. 3A is a partial isometric view from a first lateral side of spray gun 312 showing trigger 480 mounted to gun body 334. FIG. 3B is a partial isometric view from a second lateral side of spray gun 312 showing trigger 480 mounted to gun body 334. FIG. 3C is a cross-sectional view taken along line C-C in FIG. 3A. FIG. 4A is a partial isometric view from the first lateral side of spray gun 312 showing trigger 480 dismounted from gun body 334. FIG. 4B is a partial isometric view from the second lateral side of spray gun 312 showing trigger 480 dismounted from gun body 334. FIG. 4C is a cross-sectional view taken along line C-C in FIG. 4B. FIGS. 3A-3C show trigger mount 600 in a retaining state in which trigger 480 is retained on gun body 334 and operably positioned relative to valving components actuatable by trigger 480. FIGS. 4A-4C show trigger mount 600 in a mounting state in which trigger 480 can be mounted to gun body 334 or removed from gun body 334. FIGS. 4A-4C further show trigger 480 dismounted from gun body 334. FIGS. 3A-4C are discussed together.

Trigger 480 includes pull 481, arms 483a, 483b, and receiver 485. Body bore 530, of gun body 334 is shown. Body bore 530 includes bore portions 532a, 532b, 532c in the example shown. Mount opening 487a is formed in arm 483a, mount opening 487b is formed in arm 483b, and mount slot 489 is formed in arm 483b. Trigger mount 600 includes mount body 602 and spring 640. Mount body 602 includes shaft 606, pivot head 608a, and pivot head 608b. Shaft 606 includes shank 610. Pivot head 608a includes bearing surface 612a and tool interface 614a. Pivot head 608b includes bearing surface 612b and tool interface 614b. Pivot head 608b further includes head bore 618.

Trigger 480 is mountable to and dismountable from gun body 334. Trigger 480 is configured to shift in mount direction TD1 during mounting and in mount direction TD2 during dismounting. Trigger 480 can be considered to slide relative to gun body 334 during mounting and dismounting. Trigger 480 is configured to slide along a displacement axis DA during mounting and dismounting of trigger 480 on gun body 334.

Spray gun 312 is configured to receive flows of spray fluid and compressed air and to emit an atomized spray of the spray fluid for application on a target surface. Spray gun 312 is configured as a manual spray gun, though it is understood that not all examples are so limited. Gun body 334 supports other components of spray gun 312. The user can depress trigger 480 with the fingers of the hand that is grasping handle 484 to actuate spray gun 312 between the spray and non-spray states. Trigger 480 controls actuation of one or both of the spray valve 322, controlling emission of spray fluid, and the air valve 490, controlling one or more flows of compressed gas, to respective open states.

Trigger 480 is mounted to gun body 334 by trigger mount 600. Trigger 480 mount holds trigger 480 on gun body 334. In the example shown, trigger mount 600 provides a pivot point on which trigger 480 can pivot to actuate the one or more valves to respective open states. Trigger mount 600 can be considered to form a bearing pivot on which trigger 480 is rotatably supported. In the example shown, the trigger 480 is configured to pivot on pivot axis PA.

Pivot axis PA extends through gun body 334. Body bore 530 extends along pivot axis PA. In the example shown, body bore 530 extends fully laterally through gun body 334 along pivot axis PA. In the example shown, body bore 530 extends fully axially through gun body 334 along pivot axis PA. Body bore 530 is open through lateral side 534a of gun body 334 and through lateral side 534b of gun body 334.

In the example shown, body bore 530 is formed from multiple bores having different radial widths. Bore portion 532a extends into gun body 334 from lateral side 534a. Bore portion 532c extends into gun body 334 from lateral side 534b. Bore portion 532b extends between and connects bore portions 532a, 532c. In the example shown, bore portion 532a has a first radial width, bore portion 532b has a second radial width greater than the first radial width, and bore portion 532c has a third radial width greater than the second radial width. In some examples, one or more of bore portions 532a-532c are formed as cylinders. Body bore 530 can be formed by stepped cylinders in some examples. In such an example, bore portions 532a-532c can have varying diameters, with a diameter of bore portion 532c larger than a diameter of bore portion 532b, which diameter of bore portion 532b is larger than a diameter of bore portion 532a.

The varying radial widths of the bore portions 532 facilitates mounting and retention of trigger mount 600 on gun body 334. Shoulder 536a is formed between bore portion 532a and bore portion 532b. Shoulder 536a extends radially outward from pivot axis PA and can be considered to form a base of bore portion 532b. Shoulder 536b is formed between bore portion 532b and bore portion 532c. Shoulder 536b extends radially outward from pivot axis PA and can be considered to form a base of bore portion 532c. In the example shown, bore portion 532a extends from lateral side 534a to shoulder 536a, bore portion 532b extends from shoulder 536a to shoulder 536b, and bore portion 532c extends from shoulder 536b to lateral side 534b.

Mount body 602 is configured to interface with trigger 480 to connect trigger 480 to gun body 334 with trigger mount 600 in the retaining state. Mount body 602 is at least partially disposed within body bore 530. In the example shown, mount body 602 extends fully axially through body bore 530 with trigger mount 600 in the retaining state. Mount body 602 can, in some examples, extend a full length of body bore 530 with trigger mount 600 in the mounting state. Mount body 602 projects out of body bore 530 with trigger mount 600 in both the retaining state and mounting state in the example shown. Mount body 602 extends out of body bore 530 in axial direction MD2. Mount body 602 is movable relative to gun body 334 to actuate trigger mount 600 between the retaining and mounting states.

In the example shown, mount body 602 is configured to shift axially along mount axis MA to move between positions associated with the retaining state and the mounting state. In the example shown, mount body 602 is configured to shift in axial direction MD2 along mount axis MA to place trigger mount 600 in the mounting state and is configured to shift in axial direction MD1 along mount axis MA to place trigger in the retaining state. Axial directions MD1, MD2 can also be referred to as lateral directions. Mount body 602 shifts in a single lateral direction relative to gun body 334 to actuate trigger mount 600 from the retaining state to the mounting state. Mount body 602 shifts in a single lateral direction relative to gun body 334 to actuate trigger mount 600 from the mounting state to the retaining state.

In the example shown, mount body 602 interfaces with arm 483a and arm 483b of trigger 480 to mount trigger 480 to gun body 334. Pivot head 608a is disposed at a first axial end of mount body 602. Pivot head 608a is configured to interface with arm 483a. Pivot head 608a extends into mount opening 487a through arm 483a to interface with trigger 480. In the example shown, pivot head 608a extends fully axially through mount opening 487a with trigger mount 600 in the retaining state. Pivot head 608a is withdrawn from mount opening 487a with trigger mount 600 in the mounting state. In the example shown, all portions of mount body 602 are withdrawn from mount opening 487a with trigger mount 600 in the mounting state. As such, mount opening 487a is unoccupied by mount body 602 with trigger mount 600 in the mounting state. Withdrawing mount body 602 from mount opening 487a allows trigger 480 to pass over pivot head 608a and by mount body 602 during mounting and dismounting of trigger 480 on gun body 334.

Pivot head 608a has a radial width larger than the radial width of bore portion 532b. Shoulder 536b axially overlaps with pivot head 608a along mount axis MA. Shoulder 536b prevents pivot head 608a from passing in axial direction MD2 and fully through body bore 530. Such a configuration assists in retaining trigger mount 600 mounted to gun body 334 both with trigger 480 mounted to gun body 334 and with trigger 480 dismounted from gun body 334. Head face 616a of pivot head 608a is oriented axially inwards towards gun body 334. Head face 616a is oriented in axial direction MD2 and towards pivot head 608b. Head face 616a axially overlaps with shoulder 536b along mount axis MA. Head face 616a is configured to interface with shoulder 536b to limit movement of mount body 602 in axial direction MD2 through body bore 530.

In the example shown, pivot head 608a has a radial width smaller than the radial width of bore portion 532c. The smaller radial with of pivot head 608a relative to bore portion 532c facilitates pivot head 608a passing into bore portion 532c during operation. In the example shown, pivot head 608a is recessed within bore portion 532c with trigger mount 600 in the mounting state. Bearing surface 612a is annularly surrounded by the material of gun body 334 with pivot head 608a recessed in bore portion 532c, in the example shown. In some examples, pivot head 608a is fully recessed within bore portion 532c with trigger mount 600 in the mounting state such that pivot head 608a does not pass axially outward of lateral side 534b in axial direction MD1 with trigger mount 600 in the mounting state. It is understood that in some examples pivot head 608a is not disposed within gun body 334 with trigger mount 600 in the mounting state. For example, bore portion 532c can be formed to only partially surround pivot head 608a.

In the example shown, pivot head 608a is formed monolithically, but it is understood that not all examples are so limited. In some examples, pivot head 608a can be formed by multiple components functioning together. For example, a washer can brace mount body 602 to prevent displacement out of body bore 530 in first direction MD1 (the washer forming head face 616a) and a nut can provide the bearing surface for the trigger (e.g., bearing surface 612a).

Bearing surface 612a is formed on an exterior of pivot head 608a. Bearing surface 612a is a surface on which arm 483a rides with trigger 480 mounted to gun body 334 and as trigger pivots to cause spraying by spray gun 312. Bearing surface 612a can be formed as a cylindrical surface. Bearing surface 612a is disposed within mount opening 487a with trigger 480 mounted to gun body 334. In the example shown, mount opening 487a is fully radially enclosed. As such, trigger 480 can bear on bearing surface 612a 360-degrees about the mount axis MA. Such a configuration increases the operational lifespan of trigger 480 by reducing wear on the material defining mount opening 487a by distributing loads fully about the mount axis MA. Bearing surface 612a is larger than at least a portion of body bore 530 such that bearing surface 612a cannot pass axially through body bore 530.

Tool interface 614a is formed on pivot head 608a. Tool interface 614a is configured to receive torque from a tool to facilitate assembly of mount body 602. In the example shown, tool interface 614a is disposed on mount axis MA and extends into pivot head 608a along mount axis MA. For example, tool interface 614a can be formed as one or more slots, a faceted bore, etc. In the example shown, tool interface 614a is configured to receive a driver (e.g., screw driver). It is understood, however, that not all examples are so limited. For example, tool interface 614a can be formed as a faceted exterior surface, among other options.

Pivot head 608b is disposed at a second axial end of mount body 602. Pivot head 608b is disposed at an opposite end of mount body 602 from pivot head 608a. Pivot head 608b is configured to interface with arm 483b. Pivot head 608b extends into mount opening 487b through arm 483b to interface with trigger 480. In the example shown, pivot head 608b extends fully axially through mount opening 487b with trigger mount 600 in the retaining state. Pivot head 608b is withdrawn from mount opening 487b with trigger mount 600 in the mounting state. While pivot head 608b is withdrawn from mount opening 487b, mount body 602 passes through mount opening 487b with trigger mount 600 in the mounting state. In the example shown, at least a portion of mount opening 487b is occupied by mount body 602 with trigger mount 600 in both the retaining state and the mounting state and with trigger 480 in the mounting position associated with the trigger engaged state.

In the example shown, pivot head 608b is formed monolithically, but it is understood that not all examples are so limited. In some examples, pivot head 608b can be formed by multiple components functioning together. For example, a washer can brace mount body 602 to prevent displacement out of body bore 530 in direction MD2 (the washer forming head face 616b) and a nut can provide the bearing surface for the trigger (e.g., bearing surface 612b).

Slot 489 is formed in trigger arm 483b. Slot 489 extends through trigger arm 483b and is open to mount opening 487b. Slot 489 is open on a radial exterior of arm 483b relative to mount axis MA and is open through a radial exterior of mount opening 487b relative to mount axis MA. Slot 489 defines the displacement axis DA along which the trigger 480 shifts between the trigger engaged state, in which the trigger 480 is movable to open a first valve (e.g., spray valve 322 or air valve 490) s, and a disengaged state, in which the trigger 480 is spaced from the first valve assembly (e.g., assembly 338 or assembly 476) such that the first valve assembly can pass axially by the trigger 480 along the spray axis SA. Slot 489 facilitates mount body 602 passing out of mount opening 487b during dismounting of trigger 480. Mount body 602 passes out of mount opening 487b and out of overlap with trigger 480 trough slot 489. Slot 489 facilitates mount body 602 passing into mount opening 487b during mounting of trigger 480. Mount body 602 passes into overlap with trigger 480 and into mount opening 487b through slot 489. Mount body 602 moves within slot 489 as trigger 480 passes by mount body 602 during mounting and dismounting. Mount body 602 can slide within slot 489 during mounting and dismounting of trigger 480.

A width W1 of slot 489 is smaller than a radial width of pivot head 608b (e.g., diameter relative to mount axis MA), preventing trigger 480 from shifting along displacement axis DA relative to pivot head 608b with pivot head 608b disposed within mount opening 487. In the example shown, the width W1 of slot 489 is smaller than a diameter of bearing surface 612b, which bearing surface 612b is a portion of mount body 602 on which arm 483b rides with trigger mount 600 in the retaining state and holding trigger 480 on gun body 334. Shaft 606 has a radial width smaller than the width W1 of slot 489 such that trigger 480 can move along displacement axis DA relative to mount body 602 with shaft 606 passing within and through slot 489. Withdrawing pivot head 608b from mount opening 487b (e.g., by axial movement along mount axis MA) allows trigger 480 to pass by pivot head 608b (e.g., by radial movement relative to mount axis MA) during mounting and dismounting of trigger 480 on gun body 334.

Pivot head 608b has a radial width larger than the radial width of bore portion 532a. In the example shown gun body 334 axially overlaps with pivot head 608b along mount axis MA. Such a configuration assists in retaining trigger mount 600 mounted to gun body 334 both with trigger 480 mounted to gun body 334 and with trigger 480 dismounted from gun body 334. Head face 616b of pivot head 608b is oriented axially inwards towards gun body 334. Head face 616b is oriented in axial direction MD1 and towards pivot head 608a. Head face 616b axially overlaps with lateral side 534a along mount axis MA. Head face 616b is configured to interface with gun body 334 to limit movement of mount body 602 in axial direction MD1 through body bore 530. Lateral side 534a prevents pivot head 608b from passing in axial direction MD1 and fully through body bore 530. In some examples, a portion of body bore 530 extending from lateral side 534b, but not fully to bore portion 532b, has a radial width larger than the radial width of pivot head 608b. As such, pivot head 608b can partially recess within gun body 334 in some examples. Whether pivot head 608b is fully outside of gun body 334 or partially recessed in gun body 334, body bore 530 is sized such that pivot head 608b cannot pass fully through body bore 530 in axial direction MD1.

Bearing surface 612b is formed on an exterior of pivot head 608b. Bearing surface 612b is a surface of mount body 602 on which arm 483b rides with trigger 480 mounted to gun body 334 and as trigger 480 pivots to cause spraying by spray gun 312. Bearing surface 612b can be formed as a cylindrical surface. Bearing surface 612b is disposed within mount opening 487b with trigger 480 mounted to gun body 334. In the example shown, mount opening 487b is partially radially enclosed with slot 489 extending into mount opening 487b. Trigger 480 can bear on bearing surface 612b less than 360-degrees about the mount axis MA. Bearing surface 612b is larger than at least a portion of body bore 530 such that bearing surface 612b cannot pass axially through body bore 530.

In the example shown, arm 483b includes slot 489 while arm 483a does not include a corresponding slot. Mount opening 487b does not extends fully about bearing surface 612b while mount opening 487a is enclosed and does extend fully about bearing surface 612a. The single slot configuration of trigger 480 allows for unidirectional displacement of mount body 602 to actuate trigger mount 600 between states and for unidirectional displacement of trigger 480 during mounting and dismounting. The enclosed mount opening 487a provides for increased lifespan for trigger 480 by distributing wear fully about mount axis MA while the partially enclosed mount opening 487b provides for a compact configuration and simple operation of spray gun 312 and trigger mount 600 by unidirectional actuation and mounting.

Tool interface 614b is formed on pivot head 608b. Tool interface 614b is configured to receive torque from a tool to facilitate assembly of mount body 602. In the example shown, tool interface 614b is formed on a radial exterior of pivot head 608b. Tool interface 614b is disposed axially outward of bearing surface 612b relative to gun body 334. Bearing surface 612b is disposed axially between tool interface 614b and gun body 334. Tool interface 614b is formed as a faceted surface in the example shown. In the example shown, tool interface 614a is configured to be received by a torquing tool (e.g., a wrench, socket, etc.). While tool interface 614b is shown as formed on an exterior of pivot head 608b it is understood that tool interface 614b can extend into pivot head 608b to receive torque, similar to tool interface 614a.

Pivot head 608a and pivot head 608b are disposed on opposite lateral sides of gun body 334. Pivot head 608a and pivot head 608b are disposed such that at least a portion of the gun body 334 is disposed directly axially between pivot head 608a and pivot head 608b. Trigger mount 600 is configured such that mount body 602 remains mounted to gun body 334 with trigger 480 in both the trigger engaged state and the disengaged state. Pivot head 608a is sized relative to body bore 530 to prevent mount body 602 from passing out of body bore 530 in axial direction MD2. Pivot head 608b is sized relative to body bore 530 to prevent mount body 602 from passing out of body bore 530 in axial direction MD1. Mount body 602 remaining mounted to gun body 334 with trigger 480 being either mounted or dismounted simplifies operation of spray gun 312 and makes for easier operation by the user by eliminating loose parts.

Shaft 606 extends between and connects pivot head 608a and pivot head 608b. Shaft 606 is elongate along mount axis MA. Shaft 606 can be cylindrical, among other options. In some examples, the exterior surface of shaft 606 is faceted or otherwise non-circular and body bore 530 (e.g., bore portion 532a) is similarly shaped such that shaft 606 is keyed to body bore 530. Keying shaft 606 to body bore 530 prevents rotation of mount body 602 on mount axis MA such that trigger 480 can pivot about mount axis MA and move relative to mount body 602.

Shaft 606 extends between the axially inner sides of pivot heads 608a, 608b. In the example shown, shaft 606 is monolithically formed with pivot head 608a. In the example shown, shaft 606 is formed separately from and mounted to pivot head 608b. In some examples, shaft 606 and pivot head 608b can be removably mounted to each other, such as by interfaced threading between shaft 606 and pivot head 608b. Shaft 606 and pivot head 608b can be removably mounted such that torquing pivot head 608a and/or pivot head 608b on mount axis MA can break the connection between shaft 606 and pivot head 608b. In the example shown, shaft 606 include a threaded shank 610 that extends into a threaded head bore 618 in pivot head 608b to form the threaded interface between shaft 606 and pivot head 608b. In some examples, head bore 618 is open fully axially through pivot head 608b. In some examples, head bore 618 extends only partially through pivot head 608b such that head bore 618 is not open through an outer axial surface of pivot head 608b, providing a smooth outer surface for interfacing with by the user. In some examples, shaft 606 and pivot head 608b can be permanently connected, such as by press-fitting, adhesive, welding, etc. While shaft 606 is shown as monolithic with pivot head 608a in the example shown, it is understood that not all examples are so limited. For example, Shaft 606 can be integrally formed with pivot head 608b and mounted to pivot head 608a. In another example, shaft 606 can be formed separately from both pivot heads 608a, 608b and can be assembled to both pivot heads 608a, 608b. Shaft 606 extends between and connects pivot head 608a, 608b for unidirectional actuation between the retaining and mounting states.

In the example shown, shaft 606 is formed as a rigid structure that connects pivot head 608a and pivot head 608b together for simultaneous movement along mount axis MA. Shaft 606 rigidly connects pivot head 608a and pivot head 608b. Force exerted on pivot head 608a in axial direction MD2 is transmitted through shaft 606 to pivot head 608b to cause pivot head 608b to displace in axial direction MD2 together with pivot head 608a. Similarly, force exerted on pivot head 608a in axial direction MD1 is transmitted through shaft 606 to pivot head 608b to cause pivot head 608b to displace in axial direction MD2 together with pivot head 608a. Forces exerted in opposite directions on mount body 602 can cancel out. For example, exerting a first force on pivot head 608b in axial direction MD1 and a second force on pivot head 608a in axial direction MD2 can cancel out those equal forces causing mount body 602 to remain stationary.

Shaft 606 extends within body bore 530. Shaft 606 is at least partially disposed within body bore 530 with trigger mount 600 in both the retaining state and the mounting state. A smaller portion of the length of the shaft 606 is disposed within body bore 530 with trigger mount 600 in the mounting state as compared to when trigger mount 600 in the retaining state. A greater portion of the length of the shaft 606 is disposed outside of the body bore 530 with trigger mount 600 in the mounting state as compared to when trigger mount 600 in the retaining state.

Spring 640 is configured to bias trigger mount 600 to the retaining state. Spring 640 biases mount body 602 in axial direction MD1. In the example shown, spring 640 interfaces with mount body 602 to bias mount body 602 in axial direction MD1. Spring 640 interfaces with a pivot head 608a to bias mount body 602. Spring 640 interfaces with head face 616a oriented in axial direction MD2. Spring 640 extends between shoulder 536a and pivot head 608a. Spring 640 is captured axially between head face 616a and shoulder 536a. Spring 640 braces against shoulder 536a to bias mount body 602 in axial direction MD1 relative to gun body 334.

Spring 640 is disposed around a portion of mount body 602. In the example shown, spring 640 is disposed around shaft 606. Shaft 606 extends through spring 640 and axially beyond spring 640. In the example shown, shaft 606 has a radial width smaller than a radial width of the spring 640. In the example shown, the diameter of the spring 640 is greater than the diameter of the shaft 606. The diameter of the spring 640 is smaller than the diameter of bearing surface 612a. Spring 640 is formed as a coil spring in the example shown, though it is understood that not all examples are so limited.

During operation, trigger mount 600 is actuated to facilitate mounting of trigger 480 to spray gun 312 and dismounting of trigger 480 from spray gun 312. Trigger mount 600 supports trigger 480 on gun body 334 such that trigger 480 can pivot on mount axis MA and can actuate one or more valves open to cause spraying by spray gun 312. Trigger mount 600 pivotably supports trigger 480. Trigger 480 is initially dismounted from gun body 334 such that trigger 480 is disconnected from gun body 334 and not supported by gun body 334. Trigger 480 is shifted vertically upwards from a bottom side of gun body 334 such that arms 483a, 483b are disposed on opposite lateral sides 534a, 534b of gun body 334.

Trigger mount 600 is actuated to the mounting state. Mount body 602 is displaced in axial direction MD2 from the position shown in FIG. 3C to the position shown in FIG. 4C. For example, an axial force in axial direction MD2 can be applied to pivot head 608a. The force is transmitted through shaft 606 to pivot head 608b. Pivot head 608a, shaft 606, and pivot head 608b displace in axial direction MD2. Pivot head 608a is received within bore portion 532c and is recessed within body bore 530. Spring 640 is compressed between pivot head 608a and shoulder 536a. Pivot head 608b is spaced from gun body 334 such that an axial gap is formed along mount axis MA between pivot head 608b and gun body 334.

Mount body 602 is displaced from a position associated with the retaining state (FIG. 3C) to a position associated with the mounting state (FIG. 4C). Mount body 602 is displaced laterally relative to gun body 334 to the position associated with the mounting state. Mount body 602 shifts in axial direction MD2 to place trigger mount 600 in the mounting state.

With trigger mount 600 in the mounting state, mount body 602 is positioned to facilitate installation of trigger 480 on gun body 334 or removal of trigger 480 from gun body 334. Pivot head 608a is disposed axially between lateral sides 534a, 534b. Pivot head 608a is disposed axially between arm 483a and arm 483b along mount axis MA. Pivot head 608b is spaced axially outward of gun body 334. Pivot head 608b is disposed such that arm 483b is disposed axially between pivot head 608b and gun body 334. Arm 483b is disposed axially between pivot head 608b and lateral side 534b of gun body 334. Arm 483b is disposed axially between pivot head 608b and pivot head 608a. Arm 483b is disposed in an axial gap formed between pivot head 608b and lateral side 534b.

With mount body 602 in the position associated with the mounting state, trigger 480 is able to pass by mount body 602 to be mounted on gun body 334. Trigger 480 is shifted from a position associated with the disengaged state of trigger 480, in which the trigger 480 is spaced from the first valve assembly (e.g., control assembly 338, control assembly 476) such that the first valve assembly can pass axially by the trigger 480 along the spray axis SA for mounting and dismounting, to a position associated with the engaged state of trigger 480, in which the trigger 480 is movable to open the first valve of the first valve assembly.

During mounting, trigger 480 shifts upwards from a bottom side of gun body 334 and into the gap along spray axis SA between front block 494 and rear block 496. Trigger 480 shifts upwards such that gun body 334 is received in the clevis formed by arms 483a, 483b. Trigger 480 shifts upwards such that a valve shaft of a valve of spray gun 312 is disposed in receiver 485 of trigger 480. Receiver 485 is formed as a slot in the body of trigger 480 in the example shown.

Arm 483a is disposed on a first lateral side of gun body 334 during mounting of trigger 480. Arm 483a is spaced in axial direction MD1 relative to mount body 602 as trigger 480 shifts to the engaged state. Arm 483a is spaced in axial direction MD1 relative to pivot head 608a and pivot head 608b during mounting of trigger 480. In the example shown, arm 483a passes over mount body 602 such that mount opening 487a is aligned with pivot head 608a.

Arm 483b is disposed on a second lateral side of gun body 334 during mounting of trigger 480. Arm 483b is disposed axially between different portions of mount body 602. Arm 483b is disposed axially between the axial ends of mount body 602. Arm 483b is spaced in axial direction MD1 from pivot head 608b and in axial direction MD2 from pivot head 608a. Arm 483b does not radially overlap with either pivot head 608b during mounting relative to mount axis MA. Arm 483b passes by pivot head 608b at a location axially between pivot head 608b and gun body 334. In the example shown, a portion of arm 483b axially overlaps with both pivot head 608b and gun body 334 along mount axis MA during at least a portion of the displacement of trigger 480 from the disengaged state to the engaged state.

Arm 483 is positioned such that pivot head 608b is axially aligned with mount opening 487b. In the example shown, trigger 480 shifts relative to gun body 334 and/or gun body 334 shifts relative to trigger 480 such that shaft 606 passes through slot 489 and into mount opening 487b. The relative movement occurs along displacement axis DA that is aligned with slot 489. Slot 489 can be considered to define the displacement axis DA. The shaft 606 passing through slot 489 and into mount opening 487b aligns pivot head 608b with mount opening 487b. Mount opening 487b shifts radially relative to mount axis MA during mounting and dismounting of trigger 480.

With trigger 480 disposed in the position associated with the engaged state, the trigger mount 600 is actuated to the retaining state to connect trigger 480 to gun body 334. Trigger mount 600 connects trigger 480 to gun body 334 and holds trigger 480 in the engaged state. Mount body 602 shifts laterally relative to the gun body 334 and engages with trigger 480. Mount body 602 mechanically supports trigger 480 on gun body 334. In the example shown, mount body 602 is released and spring 640 displaces mount body 602 in axial direction MD1. Spring 640 exerts a driving axial force on pivot head 608a, displacing pivot head 608a and causing pivot head 608 to pull shaft 606 and pivot head 608b in axial direction MD1. Pivot head 608a shifts in axial direction MD1 and enters into mount opening 487a. Pivot head 608b shifts in axial direction MD1 and enters into mount opening 487b. Pivot heads 608a, 608b shift in the same axial direction to enter into mount openings 487a, 487b to connect trigger 480 to gun body 334.

In the example shown, pivot head 608b limits displacement in axial direction MD1. Pivot head 608b is sized such that pivot head 608b cannot pass through body bore 530 in axial direction MD1. In the example shown, an axially inner side of pivot head 608b (e.g., head face 616b) engages with gun body 334 to limit displacement of mount body 602 in axial direction MD1. Mount body 602 is thereby retained on gun body 334 with trigger mount 600 in both the retaining state and the mounting state. Mount body 602 is sized such that spring 640 does not cause mount body 602 to dismount from gun body 334 when trigger 480 is dismounted from gun body 334.

Mount body 602 displaces in axial direction MD1 to the position associated with the retaining state. In the example shown, mount body 602 is sized such that bearing surface 612a is disposed directly within mount opening 487a with mount body 602 at the limit of displacement in axial direction MD1. Mount body 602 is further sized such that bearing surface 612b is disposed directly within mount opening 487b with mount body 602 at the limit of displacement in axial direction MD1. Bearing surfaces 612a, 612b rotatably support trigger 480 on mount axis MA. Trigger 480 is pivotable on mount axis MA such that mount axis MA can also be considered to form a pivot axis.

The user can engage pull 481 with the fingers of a hand grasping trigger 480 to cause spraying by spray gun 312. In the example shown, trigger 480 can actuate both the spray valve 322 and the air valve 490 to respective open states. Trigger 480 is removable from gun body 334 to facilitate maintenance, removal, repair, etc. of a one or more spray valves. The valves can be formed as part of one or more cartridge assemblies mountable to the gun body 334. Trigger 480 is displaced from the trigger engaged state to the disengaged state to allow for mounting or removal of one or more of the valve cartridges. In the example shown, trigger 480 is fully dismounted from gun body 334 with trigger 480 in the disengaged state. Trigger 480 is disconnected from gun body 334 such that trigger 480 is not supported by gun body 334 when in the disengaged state.

Trigger 480 is dismounted by actuating trigger mount 600 from the retaining state to the mounting state and then displacing trigger 480 relative to gun body 334 and/or gun body 334 relative to trigger 480 such that gun body 334 passes out from the clevis of trigger 480. In the example shown, mount body 602 is displaced laterally such that pivot head 608a is removed from mount opening 487a and pivot head 608b is removed from mount opening 487b. A single axial input on pivot head 608a can displace each of pivot heads 608a, 608b and shaft 606 along mount axis MA. Pivot heads 608a, 608b both shift in axial direction MD2. Mount body 602 is removed from mount opening 487a and mount body 602 extends through mount opening 487b.

Trigger 480 shifts along displacement axis DA downward away from gun body 334. Gun body 334 passes from being directly between arms 483a, 483b to not being disposed directly between arms 483a, 483b. With mount body 602 in the position associated with the mounting state, trigger 480 shifts such that arm 483a passes over mount body 602 and arm 483b passes off of mount body 602. Shaft 606 passes within slot 489 to dismount arm 483b. Arm 483b radially overlaps with mount body 602 and slot 489 allows arm 483b to pass radially by mount body 602 relative to mount axis MA. Arm 483a is spaced axially outward of mount body 602 and does not radially overlap mount body 602 along mount axis MA during dismounting of trigger 480.

Trigger 480 passes by mount body 602 and is disconnected from gun body 334. After arm 483 passes by mount body 602 the mount body 602 can return to the position associated with the retaining state. Spring 640 drives mount body 602 in axial direction MD1 and back to the position associated with the retaining state. Trigger 480 is dismounted from gun body 334 while trigger mount 600 remains connected to gun body 334 and supported by gun body 334. The one or more valve cartridges can be dismounted for servicing, remounting, replacement, etc. The same or a new trigger 480 can be mounted to the gun body 334 by the trigger mount 600 to resume spraying.

Trigger mount 600 is disposed directly between at least one passage that conveys compressed gas and the spray axis SA along which the one or more valves are disposed for actuation by the trigger 480. In the example shown, common passage 502 radially overlaps with trigger mount 600 relative to spray axis SA such that both shaping and atomizing air flow radially outward of trigger mount 600 and at locations that overlap with trigger mount 600.

Trigger mount 600 is configured to provide a compact configuration for both gun body 334 and trigger 480. Trigger 480 fully dismounts from gun body 334 in the example shown. Trigger 480 fully dismounting from gun body 334 eliminates the need for elongate channels to receive mount body 602 as trigger 480 slides but remains mounted to gun body 334. It is understood that in some examples, trigger 480 can remain mounted to gun body 334 while in the disengaged state. For example, trigger 480 can include a set of secondary openings similar to mount openings 487a, 487b that are spaced from mount openings 487a, 487b along axis DA. The mount body 602 can engage the secondary openings to maintain trigger 480 mounted on gun body 334 but in a position in which trigger 480 is spaced from spray axis SA to allow for mounting and dismounting of valves on gun body 334. The compact configuration of trigger 480 reduces material and manufacturing costs and provides for a simplified configuration. Further, a single trigger 480 can be removed from one gun body 334 that is utilized for spraying with a first fluid type and utilized on a second gun body 334 that is utilized for spraying with a second fluid type. Worn triggers 480 can also be easily removed and replaced.

Mount body 602 shifts laterally relative to gun body 334 from the retaining position associated with the retaining state to the mounting position associated with the mounting state. Mount body 602 shifts axially along mount axis MA. Mount body 602 shifting in a single axial direction as a single unit facilitates a compact configuration of gun body 334. Body bore 530 does not need to be sized to receive both pivot heads 608a, 608b; instead, pivot head 608b remains outside of gun body 334 while pivot head 608a is recessed within gun body 334. Such a configuration facilitates a laterally compact gun body 334, reducing material and manufacturing costs. The compact configuration can reduce weight of gun body 334, reducing user fatigue and providing for more efficient spray operations.

Body bore 530 is disposed directly vertically between an air-conveying passage and spray axis SA. The pivot of trigger 480 is disposed at a location that is within an area defined by the various flow passages. In the example shown, the pivot of trigger 480 is disposed in an area bordered by flow passages that convey compressed gas (vertically above, longitudinally forward and behind (along the spray axis SA)) and bordered by the spray axis SA. Such an area is best seen in FIGS. 2A and 2B. Disposing the pivot in such an area facilitates a compact configuration of gun body 334, reducing material and manufacturing costs. The compact configuration can reduce weight of gun body 334, reducing user fatigue and providing for more efficient spray operations.

Mount body 602 and trigger 480 are configured such that trigger 480 shifts in a single direction during mounting and in a single direction during dismounting. Trigger 480 shifts in a first direction along displacement axis DA to mount to gun body 334 and in an opposite second direction along axis DA to dismount from gun body 334. The single-directional axial movement provides for a compact mounting footprint within which trigger 480 moves, such as compared to multi-directional movement such as with an open hook that moves up past the pivot and then over and downward. Such single directional movement also simplifies the mounting and dismounting process for the user. The user is able to fully actuate trigger mount 600 to the retaining state with a single finger. The user can apply axial force to pivot head 608a to displace mount body 602 with the single finger.

Trigger mount 600 receives a single actuating force to displace from the retaining state to the mounting state. Axial force is applied to pivot head 608a to displace mount body 602 in axial direction MD2. The single displacement disengages mount body 602 from arm 483a and from arm 483b. Applying a single axial force to disconnect trigger 480 from trigger mount 600 further facilitates forming gun body 334 and mount body 602 in compact configurations. The gun body 334 is laterally wide enough to support mount body 602 but is not required to receive multiple detents with trigger 480 disconnected. Such a configuration also provides for simpler mounting and dismounting, reducing complexity for the user and reducing downtime.

Trigger mount 600 receives a single actuating force to displace from the mounting state to the retaining state. Axial force is applied to pivot head 608a to displace mount body 602 in axial direction MD1. Spring 640 biases trigger mount 600 towards the retaining state such that trigger mount 600 is normally in the retaining state. Trigger mount 600 being normally in the retaining state maintains trigger 480 on gun body 334 without requiring additional input from the user, preventing inadvertent disconnecting of trigger 480.

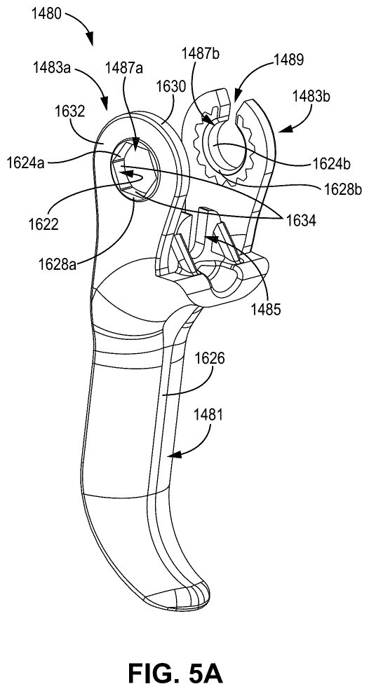

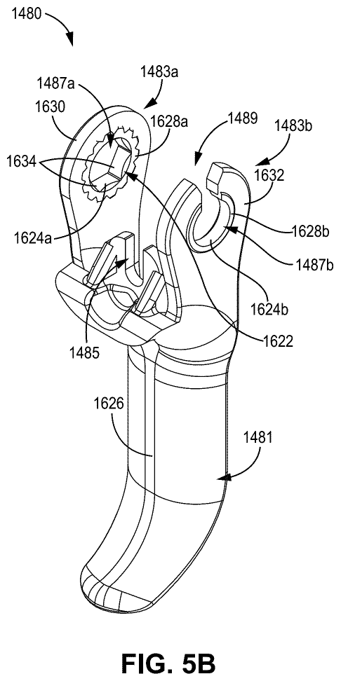

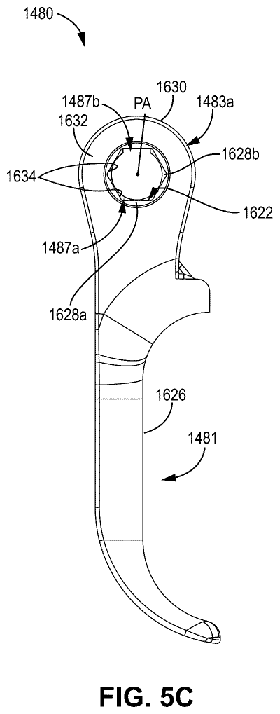

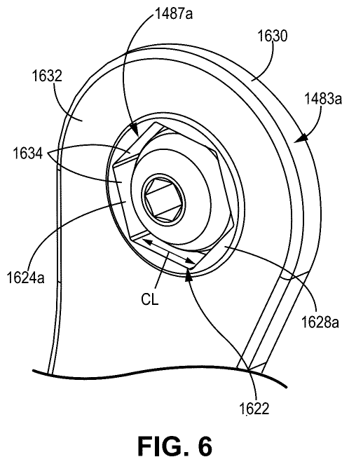

FIG. 5A is a first isometric view of trigger 1480. FIG. 5B is a second isometric view of trigger 1480. FIG. 5C is a side elevational view of trigger 1480. FIG. 6 is an enlarged isometric view of a mounting interface of a trigger 1480 on a spray gun 312. FIGS. 5A-6 are discussed together. Trigger 1480 is substantially similar to trigger 480 (best seen in FIGS. 3A-4C). Components of trigger 1480 similar to components of trigger 480 are indicated with the same reference number except increased by “1000” (e.g., pull 1481 and pull 481). Trigger 1480 includes pull 1481, arms 1483a, 1483b, receiver 1485, mount openings 1487a, 1487b, and mount slot 1489. Mount opening 1487a includes tool connector 1622 and trigger bearing surface 1624a. Mount opening 1487b includes trigger bearing surface 1624b.

Trigger 1480 is configured to mount to and dismount from gun body 334 in the same manner as trigger 480, discussed in detail above. The trigger 1480 is mountable to gun body by the trigger mount 600. Trigger mount 600 holds trigger 1480 on gun body 334. In the examples shown, trigger mount 600 provides a pivot point on which trigger 1480 can pivot to actuate the one or more valves to respective open states. Trigger mount 600 can be considered to form a bearing pivot on which trigger 1480 is rotatably supported. In the example shown, the trigger 1480 is configured to pivot on pivot axis PA.

Pull 1481 includes forward surface 1626 that is configured to be engaged by one or more fingers of the user to actuate trigger 1480 during spray operations of the spray gun 312. Arms 1483a, 1483b extend from pull 1481. Arms 1483a, 1483b are configured to be disposed on opposite lateral sides of the gun body 334 with trigger 1480 mounted to spray gun 312. Receiver 1485 is formed as a slot in the body of trigger 1480 in the example shown. Receiver 1485 is configured to extend around a valve shaft of a valve of the spray gun 312 and can axially overlap with coupler 492 such that trigger 1480 can actuate the spray valves by the structure defining the slot of receiver 1485 engaging the coupler 492.

Mount opening 1487b is formed through arm 1483b. Trigger bearing surface 1624b defines mount opening 1487b. Trigger bearing surface 1624b is configured to engage with pivot head 608b to ride on pivot head 608b. Trigger bearing surface 1624b is formed as a partial ring in the example shown. Mount slot 1489 extends through trigger arm 1483b and is open to allow the shaft 606 of trigger mount 600 to pass into and out of mount opening 1487b. The mount openings 1487a, 1487b are disposed coaxially on a pivot axis PA on which the trigger 1480 is configured to pivot when mounted to spray gun 312 to control spraying by spray gun 312.

In the example shown, the trigger bearing surface 1624b is formed by bearing piece 1628b. Bearing piece 1628b is formed separately from trigger arm 1483b and is fixed to the trigger arm 1483b. For example, trigger arm 1483b can be overmolded on bearing piece 1628b. Bearing piece 1628b can be formed from a different material than the material forming trigger arm 1483b. For example, bearing piece 1628b can be formed from metal, such as steel, carbide, etc., while trigger arm 1483b can be formed from polymer.

Mount opening 1487a is formed through arm 1483a. Trigger bearing surface 1624a defines mount opening 1487a. Trigger bearing surface 1624a is configured to engage with pivot head 608a to ride on pivot head 608a. Trigger bearing surface 1624a is formed fully annularly about the mount opening 1487a in the example shown. The mount opening 1487a is closed in the example shown.

Tool connector 1622 is formed about mount opening 1487a. Tool connector 1622 is configured to interface with surfaces of another component of spray gun 312 such that the trigger 1480 can exert force on the other component by the tool connector 1622. In the example shown, the tool connector 1622 is configured to exert torque on the other component such that trigger 1480 can drive rotational displacement of the other component by the tool connector 1622. In the example shown, the tool connector 1622 is formed as a hexed surface that extends about mount opening 1487a, though it is understood that not all examples are so limited.

In some examples, trigger 1480 can include additional or alternative tool interfaces. For example, trigger 1480 can include one or more projections that are shaped to extend into or receive the other component to exert a driving force on the other component. In some examples, the one or more projections can be shaped as a hexed projection or chamber, star, flat, Phillips head, Torx head, or other shape suitable for exerting torque on the other component. For example, the one or more projections can be configured to interface with tool interfaces 614a, 614b of the trigger mount 600. In some examples, such one or more projections can extend from an outer surface 1630 of either one or both of trigger arms 1483a, 1483b. In some examples, the one or more projections can extend from laterally outer sides 1632 of the trigger arms 1483a, 1483b. In some examples, the tool interface can be formed as one or more projections configured as a pick such as for exerting a lever force on a component or for cleaning out oof nozzle 328 or orifices through air cap 392.

In the example shown, the trigger bearing surface 1624a is formed by bearing piece 1628a. The tool connector 1622 is also formed by bearing piece 1628a. Bearing piece 1628a is formed separately from trigger arm 1483a and is fixed to the trigger arm 1483a. For example, trigger arm 1483a can be overmolded on bearing piece 1628a. Bearing piece 1628b can be formed from a different material than the material forming trigger arm 1483b. For example, bearing piece 1628b can be formed from metal, such as steel, carbide, etc., while trigger arm 1483b can be formed from polymer.

The tool connector 1622 and the trigger bearing surface 1624a are both formed by bearing piece 1628a. The tool connector 1622 is formed by a plurality of interface surfaces 1634 that extend about the mount opening 1487a to define the mount opening 1487a. The interface surfaces 1634 define a circular bearing opening inscribed in the hexagonal tool opening that is also defined by the interface surfaces 1634. The circular bearing opening is configured to receive the pivot head 608a such that the pivot head 608a rides on the portions of interface surfaces 1634 defining the inscribed circular bearing opening. In the example shown, the trigger 1480 is configured such that a portion of each interface surface 1634 rides on the pivot head 608a. In the example shown, the trigger 1480 is configured such that less than the full circumferential length CL of each interface surface 1634 contacts and rides on the pivot head 608a. Up to the full length CL of each interface surface 1634 can contact a corresponding surface on the component that the tool connector 1622 contacts to torque the other component.

Trigger 1480 provides significant advantages. Trigger 1480 can mount to spray gun 312 to actuate one or more valves of the spray gun 312 to control spraying by the spray gun 312. The trigger 1480 is configured to mount and dismount by shifting relative to gun body 334 to connect to and disconnect from trigger mount 600. The trigger bearing surfaces 1624a, 1624b ride on the pivots heads 608a, 608b, respectively, such that trigger 1480 can smoothly pivot on the mount axis MA.

Trigger 1480 is typically dismounted from spray gun 312 for servicing of the one or more spray valves of the spray gun 312. With the trigger 1480 dismounted, the tool connector 1622 can be used for manipulation of components of spray gun 312. The tool connector 1622 can be used to tighten or loosen threaded connection interfaces. The trigger 1480 can thereby provide both triggering for the spray gun 312 to control spraying and component installation and removal. The user is not required to find and use a separate tool to tighten or loosen the threaded interfaces. Instead, the user can utilize trigger 1480, which is already removed from spray gun 312 and ready for use as the tool. Such a configuration saves time and costs and provides for more efficient spray operations.

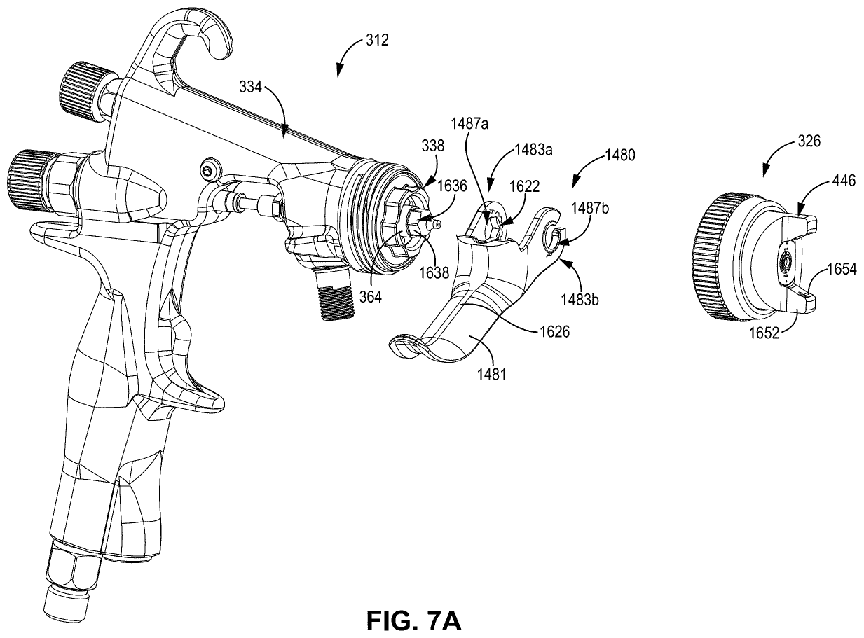

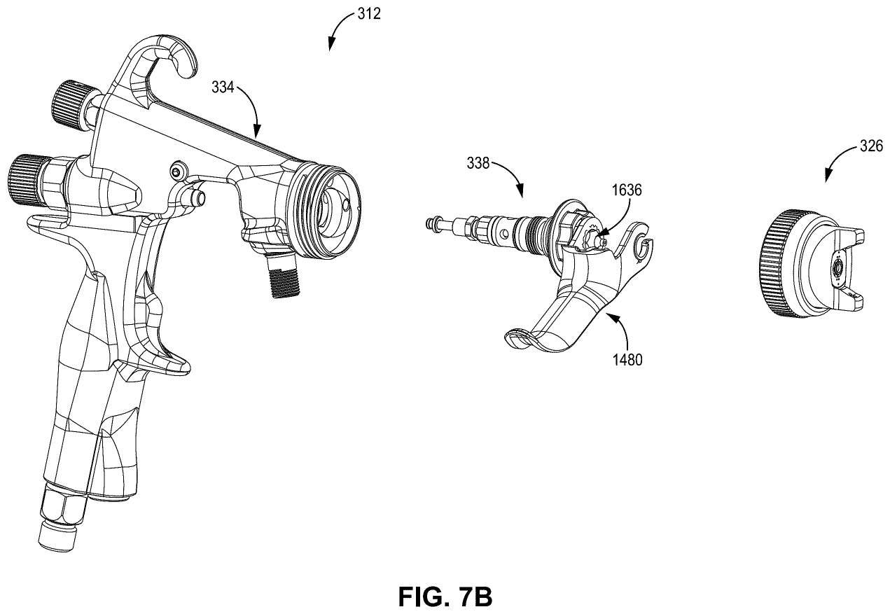

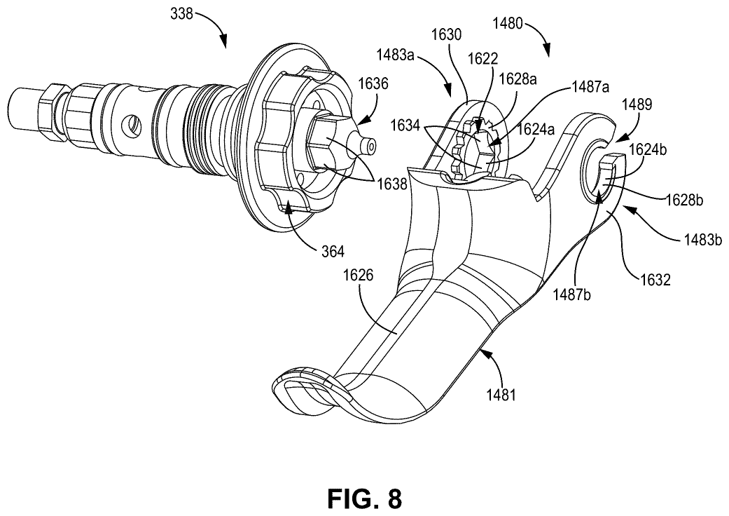

FIG. 7A is an isometric partially exploded view of spray gun 312. FIG. 7B is an isometric partially exploded view of spray gun 312. FIG. 8 is an isometric view of trigger 1480 and a spray control assembly 338. Spray control assembly 338 can also be referred to as a cartridge. FIGS. 7A-8 are discussed together.

Cartridge body 364 includes mount head 1636. Mount head 1636 is formed at a downstream end of cartridge body 364. Mount head 1636 is disposed coaxially with nozzle 328. Mount head 1636 includes a plurality of mount surfaces 1638 that are arrayed about the axis SA. The mount head 1636 forms a tool interface for the spray control assembly 338. In the example shown, the mount opening 1487a is configured to receive the mount head 1636 such that the tool connector 1622 receives and interfaces with the mount head 1636. The trigger 1480 can be rotated on the axis SA to tighten or loosen a threaded interface that mounts the spray control assembly 338 to the gun body 334.

A keyed interface is formed between cartridge body 364 and trigger 1480 in the example shown. The keyed interface prevents the trigger 1480 from rotating relative to the cartridge body 364 with the tool connector 1622 radially overlapped with the mount head 1636. It is understood that, while the keyed interface is formed by a portion of cartridge body 364 extending into a portion of trigger 1480, not all examples are so limited. For example, a portion of trigger 1480 can extend into a portion of cartridge body 364, such as by an array of prongs extending into an array of bores in cartridge body 364, among other options. The keyed interface can be formed around and coaxially with the nozzle 328. It is understood that, while a keyed interface between trigger 1480 and spray control assembly 338 is shown, the trigger 1480 can additionally or alternatively be configured to engage with a flow control assembly 476 that controls flows of compressed air through spray gun 312 to facilitate mounting and dismounting of the flow control assembly 476 by interfacing with the trigger 1480.

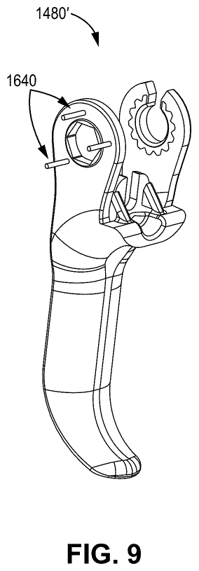

FIG. 9 is an isometric view of trigger 1480′. Trigger 1480′ is substantially similar to trigger 1480, except trigger 1480′ includes projections 1640 that are configured to extend into an interface with receivers of a component, such as a valve assembly, of a spray gun to exert force on that component for mounting or dismounting. The projections 1640 are disposed in an array about the axis PA in the example shown.

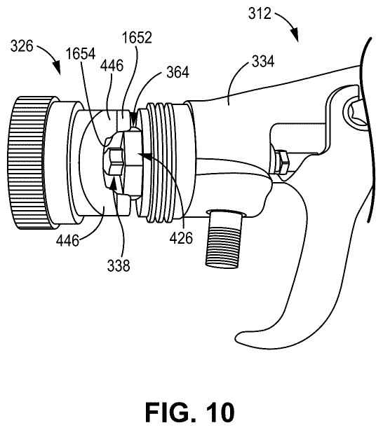

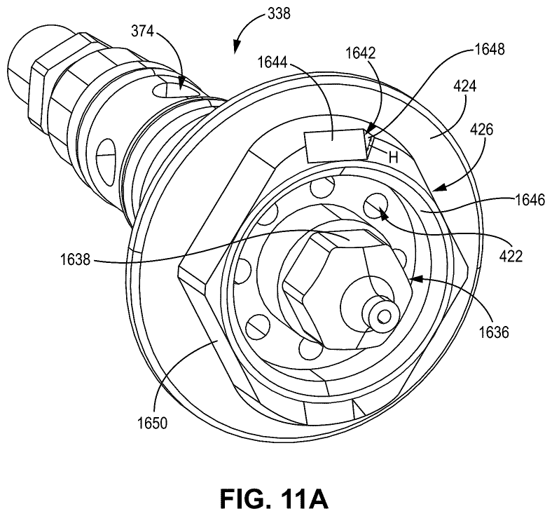

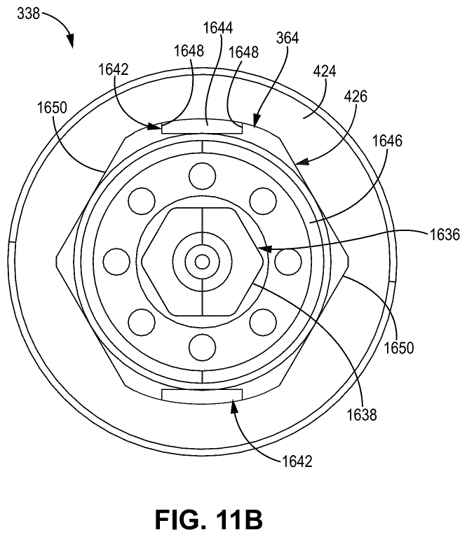

FIG. 10 is an elevational view showing engagement between an air cap 326 and spray control assembly 338. FIG. 11A is an isometric view of spray control assembly 338. FIG. 11B is an elevational end view of spray control assembly 338. Air cap 326 is configured to engage with spray control assembly 338 at a keyed interface such that air cap 326 can exert torque on spray control assembly 338 during installation and/or removal of spray control assembly 338.

Air cap 326 is configured to receive flows of compressed gas (e.g., compressed air) and to output those flows to shape and/or atomize the spray fluid output from spray control assembly 338. Air cap 326 includes horns 446 that project from a body of air cap 326. Horns 446 are configured to output a portion of the compressed gas. In the example shown, the horns 446 also form an interface component of the air cap 326 that interfaces with the spray control assembly 338 to exert torque on the spray control assembly 338.

Spray control assembly 338 is configured to be mounted to and/or dismounted from the gun body 334 of the spray gun 312 by a cartridge tool. In the example shown, the spray control assembly 338 is configured such that spray control assembly 338 can be dismounted by interfacing with a single one of multiple different tools. For example, ring 426 includes ring flats 1650 that form a faceted exterior of cartridge body 364. The ring flats 1650 can be engaged by a tool, such as a wrench, so the tool can exert torque on the spray control assembly 338 for installation or removal. Cartridge body 364 can additionally or alternatively include mount head 1636. The mount head 1636 can be engaged by a tool configured to exert torque via engagement with the mount surfaces 1638 forming the faceted exterior of mount head 1636. For example, mount head 1636 can be engaged by the trigger 1480 such that the trigger 1480 forms the cartridge tool. In some examples, the mount head 1636 can be engaged by a wrench to torque the spray control assembly 338. Spray control assembly 338 can additionally or alternatively include horn slots 1642. Horn slots 1642 form receivers on the spray control assembly 338 into which horns 446 of the air cap 326 can extend such that rotation of the air cap 326 exerts torque on the spray control assembly 338. As such, air cap 326 can form a cartridge tool.

In the example shown, the spray control assembly 338 includes horn slots 1642. Horn slots 1642 are configured to receive the horns 446 of the air cap 326. Horn slots 1642 are formed in the cartridge body 364. In the example shown, the horn slots 1642 are formed in ring 426 of cartridge body 364. The horn slots 1642 are open radially outwards away from the spray axis SA. The horn slots 1642 are closed radially inwards towards the spray axis SA. Each horn slot 1642 includes a base 1644 on an inner radial side of the horn slot 1642. The horn slots 1642 extend into a radially outer side of the ring 426 but do not extend fully radially through the ring 426. In the example shown, the horn slots 1642 do not extend into ring lip 1646 that interfaces with air cap 326 to form a sealed interface between air cap 326 and the spray control assembly 338 with the spray control assembly 338 and air cap 326 installed on the spray gun 312. The ring lip 1646 is an angled, annular surface that mates with the air cap 326.

Horn slots 1642 include side walls 1648. The side walls 1648 are disposed at the circumferential sides of the horn slot 1642. The side walls 1648 are configured to circumferentially overlap with a horn 446 of the air cap 326 with the horn 446 disposed in the horn slot 1642. The horn 446 can interface with the side wall 4648 to exert torque on the spray control assembly 338 for installation and removal. In some examples, side walls 1648 can converge towards each other as the side walls 1648 extend from the open axial end of horn slot 1642 and in the upstream direction AD1. Such a configuration can facilitate reception of the horns 446, which can include horn sides 1652 that converge towards each other as the horn 446 extends away from the body of the air cap 326.

The spray control assembly 338 includes a pair of opposed horn slots 1642. The horn slots 1642 are open axially in the downstream direction AD2. The horn slots 1642 are open axially such that horns 446 can enter into horn slots 1642 by relative axial movement between the air cap 326 and the spray control assembly 338. The horns 446 can exit from the horn slots 1642 by relative axial movement in an opposite direction.

In some examples, base 1644 of horn slot 1642 can be sloped. The horn slot 1642 can be configured such that a depth of the horn slot 1642 decreases from the open axial end of horn slot 1642 and as horn slot 1642 extends axially into cartridge body 364. The sloped base 1644 can facilitate reception and interfacing with the sloped inner surface 1654 of the horns 446. The height H of the horn slot 1642 can decrease from an open end of the horn slot 1642, through which the horn 446 can enter into and be removed from the horn slot 1642, and in the upstream direction AD1 towards collar 424.

A user can quickly and efficiently install or remove spray control assembly 338 with air cap 326. Air cap 326 is removed in order to access the spray control assembly 338 for removal. With the air cap 326 already dismounted, the air cap 326 can be turned around and directly engaged with the spray control assembly 338. The horns 446 are inserted into the opposed horn slots 1642. The air cap 326 can then be rotated to exert torque on the spray control assembly 338 to unthread the spray control assembly 338 from the spray gun 312 and remove the spray control assembly 338 for servicing or replacement. Spray control assembly 338 is installed on spray gun 312 prior to connecting air cap 326 to spray gun 312. The horns 446 can be inserted into horn slots 1642 and the air cap 326 can be rotated to exert torque on the spray control assembly 338 and threadedly engage the spray control assembly 338 and spray gun 312. Having the air cap 326 interface with the spray control assembly 338 provides time and cost savings and eliminates the need for additional tools to install or remove the spray control assembly 338.

### Discussion of Non-Exclusive Examples

The following are non-exclusive descriptions of possible examples according to various aspects of the disclosure.

A spray gun includes a gun body; a gun bore extending within the gun body, the gun bore extending along a spray axis; a body bore extending through the gun body and along a mount axis; a first valve assembly at least partially disposed within the bore, the first valve assembly including a first valve configured to control emission of spray fluid from the spray gun; a trigger mountable to the gun body, the trigger configured to actuate the first valve from a closed state to an open state, wherein the trigger is movable relative to the gun body between an engaged state, in which the trigger is movable to open the first valve, and a disengaged state, in which the trigger is spaced from the first valve assembly such that the first valve assembly can pass axially by the trigger along the spray axis; and a trigger mount configured to mount the trigger to the gun body, the trigger mount actuatable between a retaining state, in which the trigger mount connects the trigger to the gun body and holds the trigger in the engaged state, and a mounting state, in which the trigger is dismountable from the trigger mount and gun body. The trigger mount includes a mount body at least partially disposed within the body bore, the mount body projecting out of the body bore in a first direction along the axis to interface with a first arm of the trigger and the mount body projecting out of the body bore in a second direction along the axis to interface with a second arm of the trigger. The mount body is configured to displace in the second direction along the mount axis to place the trigger mount in the mounting state.

The spray gun of the preceding paragraph can optionally include, additionally and/or alternatively, any one or more of the following features, configurations and/or additional components:

The mount body includes a shaft elongate along the mount axis; a first pivot head disposed at a first end of the shaft, the first pivot head configured to interface with the first arm to mount the trigger to the gun body; a second pivot head disposed at a second end of the shaft, the second pivot head configured to interface with the second arm to mount the trigger to the gun body; the first pivot head radially larger than the shaft and the second pivot head radially larger than the shaft.

The second pivot head is disposed at least partially outside of the gun body with the trigger mount in both the retaining state and the mounting state.

The first pivot head includes a first cylindrical bearing surface on which the first arm rides with the trigger mounted to the trigger mount. The second pivot head includes a second cylindrical bearing surface on which the second arm rides with the trigger mounted to the trigger mount.

The first cylindrical bearing surface is spaced in the second direction along the mount axis from the first arm with the trigger mount in the mounting state, and wherein the second cylindrical bearing surface is spaced in the second direction along the mount axis from the second arm with the trigger mount in the mounting state.

At least one of the first pivot head and the second pivot head is formed separately from the shaft and mounted to the shaft.

The first pivot head is formed monolithically with the shaft and the second pivot head is formed separately from the shaft.

The shaft and the second pivot head and connected by a threaded interface.

The shaft and the second pivot head are press-fit together.

The first pivot head includes a first tool interface configured to receive a torquing input from a first tool, the first tool interface disposed axially outward of the first cylindrical bearing surface.

The first tool interface is disposed on the mount axis.

The second pivot head includes a second tool interface configured to receive a torquing input from a second tool, the second tool interface disposed axially outward of the second cylindrical bearing surface.

The second tool interface is formed as a faceted exterior of the second pivot head.

A diameter of the first cylindrical bearing surface is larger than at least one portion of the mount bore such that the first pivot head cannot pass through the mount bore in the second direction along the mount axis.

A diameter of the second cylindrical bearing surface is larger than at least one portion of the mount bore such that the second pivot head cannot pass through the mount bore in the first direction along the mount axis.

A diameter of the second cylindrical bearing surface is larger than at least one portion of the mount bore such that the second pivot head cannot pass through the mount bore in the first direction along the mount axis.

A spring interfacing with the mount body and biasing the mount body in the first direction along the mount axis and into the retaining state.

The spring interfaces with the gun body and the first pivot head.

The body bore includes a first bore portion having a first radial width, the first bore portion extending in the gun body from a first lateral side of the gun body; a second bore portion extending from the first bore portion and having a second radial width greater than the first radial width; wherein the mount body extends through the first bore portion and the second bore portion and the spring is braced against a first shoulder formed between the first bore portion and the second bore portion.

A diameter of the spring is larger than a diameter of the first bore portion.

The body bore further comprises a third bore portion having a third radial width, the third bore portion extending into the gun body from a second lateral side of the gun body, wherein the third radial width is greater than the second radial width.

A radial width of the first pivot head is greater than the second radial width and smaller than the third radial width.

A spring interfacing with the mount body and biasing the mount body in the first direction along the mount axis and into the retaining state.

An axial length of the mount body along the mount axis is the same with the trigger mount in the retaining state and with the trigger mount in the mounting state.

The trigger further comprises a pull; the first arm extending from the pull; the second arm extending from the pull; a first mount opening through the first arm, the mount body disposed within the first mount opening with the trigger mount supporting the trigger; and a second mount opening through the second arm, the mount body disposed within the second mount opening with the trigger mount supporting the trigger.

The mount body is removed from the first mount opening with the trigger mount in the mounting state and the trigger in a spray position associated with the engaged state, and the mount body extends through the second mount opening with the trigger mount in the mounting state and the trigger in the spray position.

The trigger further comprises a mount slot extending through the second arm and open to the second mount opening.

The mount slot defines a displacement axis along which the trigger shifts between the engaged state and the disengaged state.

The mount body slides within the mount slot during mounting and dismounting of the trigger.

The first mount opening is fully radially enclosed.

The trigger moves vertically downwards from the engaged state to the disengaged state.

The body bore is open on a first lateral side of the gun body and a second lateral side of the gun body.

A second valve assembly at least partially disposed within the bore, the second valve assembly including a second valve configured to control flow of compressed gas within the spray gun, wherein the trigger is configured to actuate the second valve from a closed state to an open state.

The first valve is spaced in a first direction along the spray axis from the trigger and the second valve is spaced in a second direction along the spray axis from the trigger.

A spray gun includes a gun body; a gun bore extending within the gun body, the gun bore extending along a spray axis; a body bore extending through the gun body and along a mount axis; a first valve assembly at least partially disposed within the bore, the first valve assembly including a first valve configured to control emission of spray fluid from the spray gun; a trigger mountable to the gun body, the trigger configured to actuate the first valve from a closed state to an open state, wherein the trigger is movable relative to the gun body between an engaged state, in which the trigger is movable to open the first valve, and a disengaged state, in which the trigger is spaced from the first valve assembly such that the first valve assembly can pass axially by the trigger along the spray axis; and a trigger mount configured to mount the trigger to the gun body, the trigger mount actuatable between a retaining state, in which the trigger mount connects the trigger to the gun body and holds the trigger in the engaged state, and a mounting state, in which the trigger is dismountable from the trigger mount and gun body. The trigger mount includes a mount body at least partially disposed within the body bore and movable relative to the gun body, the mount body configured to displace in a single direction along the mount axis to disengage from a first trigger arm of the trigger and a second trigger arm of the trigger and actuate the trigger mount from the retaining state to the mounting state.

A method of assembling a spray gun includes displacing a mount body of a trigger mount in a first direction along a mount axis of a body bore formed in a gun body of the spray gun; passing a trigger by the mount body such that a first pivot head of the mount body is aligned with a first mount opening through a first arm of the trigger and such that a second pivot head of the mount body is aligned with a second mount opening through a second arm of the trigger; and displacing the mount body in a second direction along the mount axis such that the first pivot head enters into the first mount opening and such that the second pivot head enters into the second mount opening.

The method of the preceding paragraph can optionally include, additionally and/or alternatively, any one or more of the following features, configurations and/or additional components:

Displacing the mount body in the second direction along the mount axis comprises pushing the mount body in the second direction with a spring disposed within the body bore.

Passing the trigger by the mount body further comprises passing the first arm over the first pivot head at a location axially spaced in the second direction from the first pivot head and gun body; and passing the second arm by the second pivot head at a location axially between the second pivot head and the gun body along the mount axis.

Displacing the mount body in the first direction along the mount axis to withdraw the first pivot head from the first mount opening and withdraw the second pivot head from the second mount opening; and passing the trigger by the mount body to dismount the trigger from the gun body.

A method of disassembling a spray gun includes displacing a mount body of a trigger mount in a first direction along a mount axis of a body bore formed in a gun body of the spray gun such that a first pivot head of the mount body passes out of a first mount opening through a first arm of a trigger of the spray gun and such that a second pivot head of the mount body passes out of a second mount opening through a second arm of the trigger; and passing the trigger by the mount body to dismount the trigger from the gun body.

A trigger for use with a spray gun includes a trigger pull; a first arm extending from thee trigger pull; a second arm extending from the trigger pull; a first mount opening formed through the first arm, the first mount opening including a first trigger bearing surface configured to ride on a pivot of the spray gun during actuation of the trigger; a second mount opening formed through the second arm, the second mount opening including a second trigger bearing surface configured to ride on the pivot of the spray gun during actuation of the trigger; and a tool connector configured to interface with a component of the spray gun to exert a force on the component of the spray gun during one or both of mounting and dismounting of the component.

The trigger of the preceding paragraph can optionally include, additionally and/or alternatively, any one or more of the following features, configurations and/or additional components:

The tool connector at least partially defines the first mount opening.

The tool connector is at least partially formed by the first trigger bearing surface.

The first mount opening is at least partially defined by a plurality of interface surfaces that extend about the first mount opening, and wherein the plurality of interface surfaces form both the first bearing surface and the tool connector.

The first mount opening and the second mount opening are disposed coaxially on a pivot axis.

The first mount opening is non-circular.

The second mount opening is circular.

The tool connector is configured to torque the component.

The tool interface includes one or more projections extending from the first arm.

The one or more projections includes a plurality of projections that are arrayed about an axis.

A first bearing piece connected to the first arm and defining the first mount opening, wherein the first bearing piece is formed from a first material and the first arm is formed from a second material different from the first material.

The first material is a metal.

The second material is a polymer.

A second bearing piece connected to the second arm and defining the second mount opening.

A mount slot is formed through the second arm and open into the second mount opening.

A method of servicing a spray gun includes disconnecting a trigger from a gun body of the spray gun; interfacing the trigger with a component of the spray gun; and exerting force on the component, by the trigger, to disconnect the component from the spray gun.

The method of the preceding paragraph can optionally include, additionally and/or alternatively, any one or more of the following features, configurations and/or additional components:

Interfacing the trigger with the component of the spray gun comprises interfacing the trigger with a valve cartridge supported by a gun body of the spray gun.

Interfacing the trigger with the component of the spray gun comprises receiving a portion of the component within a tool connector of the trigger.

Interfacing the trigger with the component of the spray gun comprises receiving a portion of a tool connector of the trigger within the component.

Interfacing the trigger with the valve cartridge supported by the gun body of the spray gun comprises receiving a portion of the valve cartridge within a first mount opening through a first arm of the trigger, wherein the first mount opening receives a pivot head such that the trigger rides on the pivot head with the trigger mounted to the gun body.

Exerting force on the component, by the trigger, to disconnect the component from the spray gun comprises exerting torque on the component by the trigger.

Exerting force on the component, by the trigger, to disconnect the component from the spray gun comprises driving rotation of the component by the trigger to loosen a threaded interface holding the component.

A cartridge for a spray gun includes a cartridge body extending along an axis and defining a flow chamber within an interior of the cartridge body; a nozzle formed at a first end of the cartridge body, the nozzle configured to output spray fluid from the flow chamber in a first direction along the axis; at least one fluid port extending through the cartridge body between the exterior of the cartridge body and the flow chamber formed within an interior of the cartridge body; and a first horn slot formed in the cartridge body and a second horn slot formed in the cartridge body, the first horn slot and the second horn slot open in the first direction along the axis.

The cartridge of the preceding paragraph can optionally include, additionally and/or alternatively, any one or more of the following features, configurations and/or additional components:

The cartridge body includes an axially projecting ring, the first horn slot is formed on the ring, and the second horn slot is formed on the ring.

The first horn slot is open radially outward and closed radially inward.

The first horn slot does not extend fully radially through the ring.

The first horn slot is disposed 180-degrees about the axis from the second horn slot.

A method of servicing a spray gun, includes disconnecting an air cap from a gun body of the spray gun; interfacing the air cap with a component of the spray gun; and exerting force on the component, by the air cap, to disconnect the component from the spray gun.

The method of the preceding paragraph can optionally include, additionally and/or alternatively, any one or more of the following features, configurations and/or additional components:

Interfacing the air cap with the component of the spray gun comprises inserting a first horn of the air cap into a first horn slot of a cartridge mounted to the spray gun and a second horn of the air cap into a second horn slot of the cartridge.

Exerting force on the component, by the air cap, to disconnect the component from the spray gun comprises rotating the air cap on an axis to exert torque on the cartridge and cause rotation of the cartridge relative to the gun body.

Exerting force on the component, by the air cap, to disconnect the component from the spray gun comprises rotating the air cap on an axis to exert torque on the component.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A spray gun comprising:
a gun body;
a gun bore extending within the gun body, the gun bore extending along a spray axis;
a body bore extending through the gun body and along a mount axis;
a first valve assembly at least partially disposed within the bore, the first valve assembly including a first valve configured to control emission of spray fluid from the spray gun;
a trigger mountable to the gun body, the trigger configured to actuate the first valve from a closed state to an open state, wherein the trigger is movable relative to the gun body between an engaged state, in which the trigger is movable to open the first valve, and a disengaged state, in which the trigger is spaced from the first valve assembly such that the first valve assembly can pass axially by the trigger along the spray axis; and
a trigger mount configured to mount the trigger to the gun body, the trigger mount actuatable between a retaining state, in which the trigger mount connects the trigger to the gun body and holds the trigger in the engaged state, and a mounting state, in which the trigger is dismountable from the trigger mount and gun body, the trigger mount comprising:
a mount body at least partially disposed within the body bore, the mount body projecting in a first direction along the axis to interface with a first arm of the trigger and the mount body projecting in a second direction along the axis to interface with a second arm of the trigger;
the mount body configured to displace in the second direction along the mount axis to place the trigger mount in the mounting state.

2. The spray gun of claim 1, wherein the mount body comprises:
a shaft elongate along the mount axis;
a first pivot head disposed at a first end of the shaft, the first pivot head configured to interface with the first arm to mount the trigger to the gun body; and
a second pivot head disposed at a second end of the shaft, the second pivot head configured to interface with the second arm to mount the trigger to the gun body;
the first pivot head radially larger than the shaft and the second pivot head radially larger than the shaft.

3. The spray gun of claim 2, wherein the second pivot head is disposed at least partially outside of the gun body with the trigger mount in both the retaining state and the mounting state.

4. The spray gun of claim 2, wherein:
the first pivot head includes a first cylindrical bearing surface on which the first arm rides with the trigger mounted to the trigger mount; and
the second pivot head includes a second cylindrical bearing surface on which the second arm rides with the trigger mounted to the trigger mount.

5. The spray gun of claim 4, wherein the first cylindrical bearing surface is spaced in the second direction along the mount axis from the first arm with the trigger mount in the mounting state, and wherein the second cylindrical bearing surface is spaced in the second direction along the mount axis from the second arm with the trigger mount in the mounting state.

6. The spray gun of claim 4, wherein the shaft and the second pivot head are connected by one of a threaded interface and a press-fit interface.

7. The spray gun of claim 4, wherein a diameter of the first cylindrical bearing surface is larger than at least one portion of the mount bore such that the first pivot head cannot pass through the mount bore in the second direction along the mount axis.

8. The spray gun of claim 2, further comprising:
a spring interfacing with the mount body and biasing the mount body in the first direction along the mount axis and into the retaining state.

9. The spray gun of claim 8, wherein the spring interfaces with the gun body and the first pivot head.

10. The spray gun of claim 8, wherein the body bore comprises:
a first bore portion having a first radial width, the first bore portion extending in the gun body from a first lateral side of the gun body; and
a second bore portion extending from the first bore portion and having a second radial width greater than the first radial width;
wherein the mount body extends through the first bore portion and the second bore portion and the spring is braced against a first shoulder formed between the first bore portion and the second bore portion.

11. The spray gun of claim 10, wherein the body bore further comprises:
a third bore portion having a third radial width, the third bore portion extending into the gun body from a second lateral side of the gun body, wherein the third radial width is greater than the second radial width.

12. The spray gun of claim 1, further comprising:
a spring interfacing with the mount body and biasing the mount body in the first direction along the mount axis and into the retaining state.

13. The spray gun of claim 1, wherein an axial length of the mount body along the mount axis is the same with the trigger mount in the retaining state and with the trigger mount in the mounting state.

14. The spray gun of claim 1, wherein the trigger further comprises:
a pull;
the first arm extending from the pull;
the second arm extending from the pull;
a first mount opening through the first arm, the mount body disposed within the first mount opening with the trigger mount supporting the trigger; and
a second mount opening through the second arm, the mount body disposed within the second mount opening with the trigger mount supporting the trigger.

15. The spray gun of claim 14, wherein the trigger further comprises:
a tool connector configured to interface with the first valve assembly to exert a force on the first valve assembly during one or both of mounting and dismounting of the first valve assembly.

16. The spray gun of claim 15, wherein the tool connector at least partially defines the first mount opening.

17. The spray gun of claim 14, wherein the tool connector is at least partially formed by the first trigger bearing surface.

18. The spray gun of claim 14, wherein the mount body is removed from the first mount opening with the trigger mount in the mounting state and the trigger in a spray position associated with the engaged state, and the mount body extends through the second mount opening with the trigger mount in the mounting state and the trigger in the spray position.

19. A spray gun comprising:
a gun body;
a gun bore extending within the gun body, the gun bore extending along a spray axis;
a body bore extending through the gun body and along a mount axis;
a first valve assembly at least partially disposed within the bore, the first valve assembly including a first valve configured to control emission of spray fluid from the spray gun;
a trigger mountable to the gun body, the trigger configured to actuate the first valve from a closed state to an open state, wherein the trigger is movable relative to the gun body between an engaged state, in which the trigger is movable to open the first valve, and a disengaged state, in which the trigger is spaced from the first valve assembly such that the first valve assembly can pass axially by the trigger along the spray axis; and
a trigger mount configured to mount the trigger to the gun body, the trigger mount actuatable between a retaining state, in which the trigger mount connects the trigger to the gun body and holds the trigger in the engaged state, and a mounting state, in which the trigger is dismountable from the trigger mount and gun body, the trigger mount comprising:
a mount body at least partially disposed within the body bore and movable relative to the gun body, the mount body configured to displace in a single direction along the mount axis to disengage from a first trigger arm of the trigger and a second trigger arm of the trigger and actuate the trigger mount from the retaining state to the mounting state.

20. A method of assembling a spray gun, the method comprising:
displacing a mount body of a trigger mount in a first direction along a mount axis of a body bore formed in a gun body of the spray gun;
passing a trigger by the mount body such that a first pivot head of the mount body is aligned with a first mount opening through a first arm of the trigger and such that a second pivot head of the mount body is aligned with a second mount opening through a second arm of the trigger; and
displacing the mount body in a second direction along the mount axis such that the first pivot head enters into the first mount opening and such that the second pivot head enters into the second mount opening.
